(19) United States
(12) Patent Application Publication
(10) Pub. No.: US 2026/0289453 A1
(43) Pub. Date: Sep. 24, 2026

(54) SYSTEM

(71) Applicant: SoftBank Group Corp., Tokyo (JP)

(72) Inventor: Naoki EGAWA, Tokyo (JP)

(73) Assignee: SoftBank Group Corp., Tokyo (JP)

(21) Appl. No.: 19/568,944

(22) Filed: Mar. 17, 2026

(30) Foreign Application Priority Data
Mar. 19, 2025 (JP) 2025-045211

(51) Int. Cl. G06Q 10/0631; G06N 3/0475; G06Q 10/40

(52) U.S. Cl. CPC G06Q 10/06315; G06N 3/0475; G06Q 10/40

(57) ABSTRACT

A system includes a processor that is configured to receive, as input, information including at least family composition, required nutrients, calorie information, user dietary preferences, user allergy information, and an emotional state of a user, generate, based on the received information, a prompt for instructing a generative artificial intelligence model to propose one or more meal plans, compare ingredients required by the proposed meal plans with ingredient information representing ingredients possessed by the user, identify ingredients that are insufficient, and automatically place an order for at least a portion of the insufficient ingredients as needed, and cause the proposed meal plans to be displayed via a user interface in a format that allows ordering through a food delivery service.

### CROSS-REFERENCE TO RELATED APPLICATION

This application is based on and claims priority under 35 USC 119 from Japanese Patent Application No. 2025-045211 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional meal planning systems typically focus on static nutritional parameters such as calories and basic nutrient balance, and in some cases allow the user to manually register food preferences or allergies. However, such systems generally require the user to perform multiple independent operations: selecting recipes, checking available ingredients, identifying missing ingredients, and then separately placing orders with food delivery or grocery services. This fragmented flow not only increases user burden but also leads to inconsistent adherence to nutritional goals, diet targets, and allergy constraints. Moreover, conventional systems do not adequately consider the emotional state of the user, and therefore fail to propose meals and ingredients that support stress reduction or emotional well-being. As generative artificial intelligence models become capable of flexibly proposing diverse meal plans, there is a further problem that users lack a unified mechanism to convert rich AI-generated meal suggestions into concrete, executable actions including inventory management and ordering. Accordingly, there is a need for a system that, while leveraging generative artificial intelligence for meal plan creation, can integrate user nutritional requirements, preferences, allergies, and emotional state, automatically manage inventory and ordering, and present the resulting meal plans in a format directly usable for food delivery services.

### SUMMARY

In order to solve the above-mentioned problems, the present invention provides a system comprising a processor configured to receive, as input, information including at least family composition, required nutrients, calorie information, user dietary preferences, user allergy information, and an emotional state of a user. Based on these inputs, the processor generates a prompt that instructs a generative artificial intelligence model to propose one or more meal plans tailored to the user's nutritional requirements, preferences, and constraints. The processor then compares ingredients required by the proposed meal plans with ingredient information representing ingredients possessed by the user, identifies insufficient ingredients, and automatically places an order for at least a portion of the insufficient ingredients when needed. The processor further causes the proposed meal plans to be displayed via a user interface in a format that allows ordering through a food delivery service, thereby enabling the user to execute the proposed meal plans with minimal manual operations. In certain embodiments, the processor is configured to propose the one or more meal plans based on a specific goal, such as weight loss, muscle gain, or disease management, and to manage an inventory of ingredients based on the proposed meal plans. In other embodiments, the processor is configured to analyze the emotional state of the user and to propose one or more ingredients or meals that support stress reduction or sharing of joy, thereby dynamically linking emotional care with everyday meal planning and ordering.

The term “processor” refers to any hardware, firmware, or combination of hardware and software configured to execute instructions, including but not limited to a central processing unit (CPU), a microcontroller, a system-on-chip (SoC), or a distributed set of processing resources operating together as a logical processor.

The term “family composition” refers to information representing the number of persons constituting a household and, optionally, attributes of each person such as age, sex, or dietary classification, used for calculating meal portions and nutritional requirements.

The term “required nutrients” refers to target amounts or ranges of nutritional components, such as protein, fat, carbohydrates, vitamins, minerals, or other dietary elements, that are to be satisfied by one or more meal plans for a specific period of time.

The term “calorie information” refers to information indicating a target energy intake amount or range, typically expressed in kilocalories or kilojoules, to be achieved by one or more meal plans for a given user or household.

The term “user dietary preferences” refers to information describing foods or ingredients that a user prefers or dislikes, including but not limited to favorite foods, avoided foods, or preferred cooking styles, and that is used to influence selection of meals or ingredients.

The term “user allergy information” refers to information indicating foods, ingredients, or substances that the user should avoid for medical or health reasons, including but not limited to allergens such as shellfish, nuts, dairy, or gluten.

The term “emotional state of a user” refers to information representing a psychological or affective condition of the user, such as stress, happiness, sadness, excitement, or relaxation, obtained through explicit user input, sensor data, or inference by a model.

The term “generative artificial intelligence model” refers to a machine learning model configured to generate content, such as text, images, or structured data, in response to an input prompt, including but not limited to large language models, generative adversarial networks, or variational autoencoders.

The term “prompt” refers to data including text, structured parameters, or tokens that is provided as input to a generative artificial intelligence model in order to specify a request for generation of one or more meal plans or related information.

The term “meal plan” refers to a structured proposal of one or more meals for one or more time periods, such as days or weeks, including at least an identification of dishes, required ingredients, and optionally associated nutritional or caloric values.

The term “ingredient information” refers to data representing ingredients possessed by the user, including at least an identification of each ingredient and a quantity or availability status, and optionally units, expiration dates, or storage locations.

The term “insufficient ingredients” refers to ingredients for which a required quantity derived from one or more meal plans exceeds a corresponding available quantity in the ingredient information representing ingredients possessed by the user.

The term “automatically place an order” refers to causing an order request for one or more items to be transmitted, without requiring the user to manually enter all order details, to an external ordering system such as a grocery service or food delivery service.

The term “user interface” refers to any hardware, software, or combination thereof that presents information to the user and receives input from the user, including but not limited to graphical user interfaces on smartphones, tablets, computers, smart displays, or voice-based interfaces.

The term “food delivery service” refers to an external service, operated by a third party or by the same entity as the system, that receives orders for prepared meals or ingredients and arranges for delivery of the ordered items to a location specified by the user.

The term “specific goal” refers to a user-defined or system-determined objective related to diet or health, including but not limited to weight loss, weight gain, muscle gain, blood sugar control, or adherence to a particular dietary regimen.

The term “inventory of ingredients” refers to a record managed by the processor representing the types and quantities of ingredients currently available to the user, updated based on consumption, replenishment, and automatic or manual orders.

The term “stress reduction” refers to a decrease in a user's perceived or measured stress level, which is supported by selection of meals or ingredients associated with relaxation, comfort, or other stress-alleviating effects.

The term “sharing joy” refers to supporting or enhancing a positive emotional experience, such as happiness or celebration, through the selection of meals or ingredients that are associated with enjoyment, special occasions, or social sharing.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

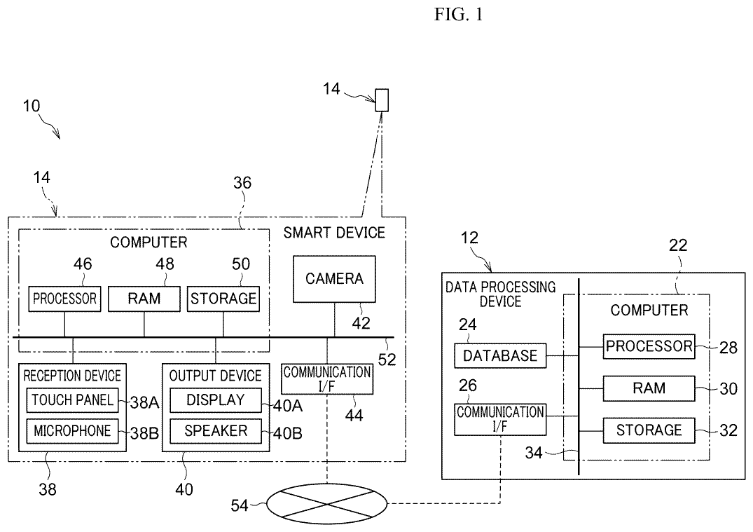

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

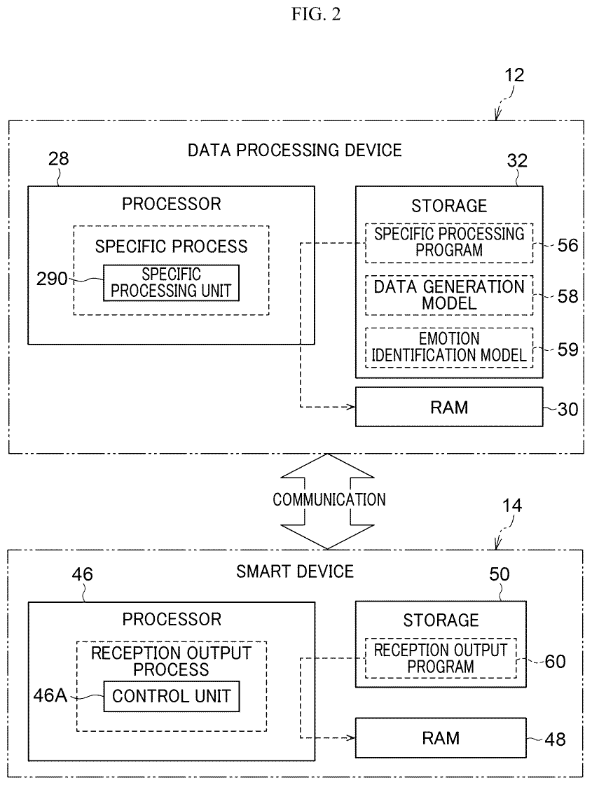

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented meal planning systems typically perform rule-based selection of dishes from a database using static filters on calories, nutrients, or simple user preferences. Such systems are limited in several respects. First, these systems often generate rigid or repetitive meal plans that do not adequately reflect complex combinations of user attributes, such as heterogeneous family composition, detailed nutritional targets, allergies, and dynamically changing emotional states. Second, existing systems frequently treat menu generation, nutritional verification, and ingredient inventory management as separate processes, which leads to inconsistent data handling, redundant computation, and poor synchronization between planned meals and available ingredients. Third, many systems that integrate with content generation engines or recommendation engines do not tightly couple natural-language generation with structured nutritional computation, resulting in outputs that are human-readable but not machine-verifiable or directly usable for precise ingredient calculations and automatic ordering.

From the perspective of computer technology, there is a need for an improved processing architecture that (i) integrates generative models using prompt sentences with structured nutritional data processing in a unified server-side pipeline, (ii) automatically transforms free-form generated meal plan information into normalized component information suitable for numerical computation, and (iii) maintains a consistent and automatically updated ingredient inventory by computing exact shortages and converting them into structured order information for external services. Without such an architecture, server resources are inefficiently used, data structures remain fragmented, and the system cannot reliably scale to handle high volumes of users with diverse and dynamically changing conditions.

Accordingly, a technical problem to be solved is to provide a computer-implemented system and server-side processing method that improve how a processor generates, verifies, and corrects meal plan information by combining generative AI outputs with structured nutritional databases, and that further improve how the processor automatically calculates required component amounts, identifies shortages based on user inventory information, and produces shopping list and order information in a format directly usable by external provision services, while optionally incorporating emotional state information as a first-class parameter in the computational pipeline. By addressing this problem, the invention aims to enhance the efficiency, consistency, and technical robustness of server-side meal planning and inventory management operations.

The specific processing by the specific processing unit 290 of the data processing device 12 in Example 1 is realized by the following means.

The present invention provides a server comprising a processor configured to receive, from a terminal, user attribute information and nutritional condition information, to generate a prompt sentence including the user attribute information and the nutritional condition information, and to input the prompt sentence to a generative information processing model so as to cause the generative information processing model to output meal plan information; to acquire, from a nutrition information storage device, component information corresponding to dish information included in the meal plan information, and to calculate nutritional value information and energy amount information for each dish and for a predetermined period; to compare the calculated nutritional value information and energy amount information with the nutritional condition information, and to generate corrected meal plan information by changing dish candidate information or serving amount information in accordance with deviation from a target value; to calculate required component amount information based on component information included in the corrected meal plan information, to compare the required component amount information with user inventory information, to identify shortage component information, and to generate shopping list information; and to transmit the corrected meal plan information and the shopping list information to the terminal, to provide the corrected meal plan information and the shopping list information in a format displayable by a user interface, and to convert the shortage component information into order information in a format transmittable to an external provision service. This enables a unified, server-side computational workflow that tightly couples generative AI model output with structured nutritional computation and inventory control, thereby improving the technical operation of the computer system by automatically transforming natural-language meal plans into normalized, verifiable data structures, reducing redundant processing, maintaining consistent inventory records, and producing machine-ready order information for external services while optionally incorporating emotional state information into the same processing pipeline.

The term “user attribute information” refers to information indicating characteristics of a user or a group of users, including at least one of family composition, age group, sex, lifestyle patterns, dietary preferences, allergy information, and emotional state information.

The term “nutritional condition information” refers to information specifying one or more nutritional requirements or constraints for meals, including at least one of target energy intake, target nutrient amounts, nutrient balance conditions, dietary restrictions, and period of application.

The term “prompt sentence” refers to a sequence of machine-readable natural-language or structured text that includes at least a portion of the user attribute information and the nutritional condition information and that is supplied as an input to a generative information processing model in order to cause the generative information processing model to generate an output.

The term “generative information processing model” refers to a data-driven computational model, such as a machine learning model or neural network model, configured to generate output information, including at least meal plan information, in response to an input prompt sentence.

The term “meal plan information” refers to information specifying one or more meals for a predetermined period, including at least dish information, serving amount information, and optionally time or date information.

The term “dish information” refers to information identifying a prepared food item or meal component, including at least a dish name and being associated with one or more component information items in a nutrition information storage device.

The term “component information” refers to information identifying a food ingredient, food material, or other consumable element that constitutes at least part of a dish, and including at least one of a component identifier, quantity information per serving, and nutritional attribute information.

The term “nutrition information storage device” refers to a storage apparatus, such as a database system or memory device, that stores component information and associated nutritional attribute information, and that is accessible by the processor.

The term “nutritional value information” refers to information indicating quantitative values of one or more nutritional attributes, including at least one of energy, protein, fat, carbohydrate, vitamins, and minerals, calculated for at least one dish or for a predetermined period.

The term “energy amount information” refers to information indicating a quantitative value of energy, such as a caloric value, for at least one dish or for a predetermined period.

The term “corrected meal plan information” refers to meal plan information that has been modified by the processor based on comparison of nutritional value information and energy amount information with the nutritional condition information, including at least changes to dish candidate information or serving amount information.

The term “dish candidate information” refers to information representing one or more selectable dish options that can be included in the meal plan information, including at least a dish identifier or dish name.

The term “serving amount information” refers to information indicating a quantity or portion size of a dish or component to be provided to one or more users in a meal.

The term “required component amount information” refers to information indicating, for each component, a total quantity required to implement the corrected meal plan information over a predetermined period.

The term “user inventory information” refers to information indicating current quantities and identifiers of components that are already available to a user, stored for example in a pantry, refrigerator, or other storage, and managed by the system.

The term “shortage component information” refers to information identifying one or more components for which the required component amount exceeds the quantity indicated in the user inventory information, and indicating at least a shortage quantity for each such component.

The term “shopping list information” refers to information derived from the shortage component information and indicating a list of components and associated quantities to be acquired by the user, formatted for presentation or for further processing.

The term “order information” refers to structured information representing a request to obtain one or more components from an external provision service, including at least component identifiers, quantities, and optionally delivery or transaction details.

The term “external provision service” refers to an external system or service, such as a delivery service system or product supply system, that is capable of receiving order information and providing corresponding components to the user.

The term “emotional state information” refers to information indicating at least one aspect of a user's or users' emotional or psychological condition, such as stress level, mood, or desired emotional effect, and usable as part of the user attribute information in generating or adjusting meal plan information.

In one embodiment, a server cooperates with one or more terminals operated by a user in order to generate, correct, and supply meal plan information and associated shopping list information. The server includes at least one processor, a memory, a network interface, and accesses a nutrition information storage device implemented, for example, as a relational database. The terminal includes at least a processor, a display device, an input device such as a touch panel, and a communication interface. The user operates the terminal to provide user attribute information and nutritional condition information to the server and to receive and display information generated by the server.

The server executes application software implemented, for example, using a server-side framework such as a web application framework, and a machine learning execution environment such as a tensor computation library. The server further accesses a generative AI model implemented as a neural network, for example, a transformer-based language model trained on nutritional and culinary text data. The server stores executable instructions and data structures in the memory and performs data processing by executing the instructions on the processor.

The server uses specific data structures for internal processing. The server represents user attribute information as a structured record including fields such as a user identifier, family composition category, age group category, dietary preference category, allergy category, and emotional state category. The server represents nutritional condition information as a structured record including fields such as target daily energy value, target nutrient ranges, diet type category, and planning period. The server represents dish information as records including dish identifiers, canonical names, and references to component information records.

The server represents component information as records including component identifiers, unit types, per-unit nutritional attributes, and category attributes. These records are stored in the nutrition information storage device.

The server accesses a generative AI model configured as a multi-layer neural network that receives a sequence of tokens representing a prompt sentence and outputs a sequence of tokens representing generated meal plan information. The generative AI model uses an encoder-decoder architecture or a decoder-only transformer architecture having multiple attention layers, feed-forward layers, and normalization layers. The generative AI model is trained using supervised learning on text corpora containing descriptions of meals, recipes, nutritional guidelines, and menu plans. During training, the generative AI model minimizes a loss function such as cross-entropy between predicted token distributions and ground-truth tokens. The model parameters, including weight matrices in attention and feed-forward layers, are updated using a gradient-based optimization algorithm such as stochastic gradient descent with momentum or adaptive methods. The generative AI model uses token embeddings to map words or sub-words into high-dimensional feature vectors and uses positional encodings to preserve sequence order.

The server stores the trained generative AI model parameters in a model storage and loads them into memory at runtime. The server communicates with the generative AI model either as a local library or through a dedicated model server endpoint. In either case, the server provides a prompt sentence as a sequence of tokens and receives generated text as an output sequence of tokens, which the server decodes into a natural-language meal plan description.

The server generates the prompt sentence by concatenating specific segments derived from the structured user attribute information and the nutritional condition information. For example, the server may generate a prompt sentence such as:

“Generate a nutritionally balanced 7-day dinner menu for a household of four, including two adults and two children. The target energy intake is 2000 kilocalories per person per day.

Emphasize high protein and low sugar intake, and strictly avoid peanuts and shellfish.

Propose dishes using commonly available ingredients and output the menu as a day-by-day list with dish names and brief descriptions.”

The server encodes this prompt sentence into tokens suitable for input to the generative AI model. By structuring the prompt sentence according to a predefined template and by including normalized user attribute values and nutritional constraints, the server ensures that the generative AI model receives consistent, machine-derivable instructions. This structured prompting reduces the entropy of the model's output space and improves reproducibility and accuracy of generated meal plans compared to unstructured natural-language queries.

The server receives generated meal plan information from the generative AI model as free-form text. The server then performs a sequence of deterministic parsing operations to convert the free-form text into structured meal plan information. The server uses a text segmentation algorithm implemented, for example, as rule-based parsing combined with token pattern matching, to identify day boundaries, meal types, and dish names. The server then associates each dish name with canonical dish information stored in the nutrition information storage device. To perform this association, the server uses a similarity search mechanism, for example, a combination of string normalization, token-based similarity scoring, and vector-based similarity using learned embeddings of dish names. The server computes similarity scores and selects canonical dishes that exceed a predefined threshold. This processing converts the high-level textual output of the generative AI model into normalized identifiers that can be used for exact numerical computation.

The server calculates nutritional value information and energy amount information by retrieving component information for each canonical dish. The server executes queries against the nutrition information storage device to obtain, for each component, per-unit nutritional attributes including energy, protein, fat, carbohydrate, and specific micronutrients.

The server then multiplies these attributes by serving amount information associated with each dish and aggregates the results over each meal, each day, and the entire planning period.

The server uses floating-point arithmetic operations on the processor to compute sums and averages. By aggregating nutritional values in this structured manner, the server can verify whether the generated meal plan information satisfies the nutritional condition information defined by the user.

The server compares the computed nutritional value information and energy amount information with the nutritional condition information. The server evaluates deviation metrics such as absolute difference, percentage difference, and constraint satisfaction flags for each nutrient and for total energy. When the server detects that particular nutrients fall outside target ranges, or that total energy deviates beyond a threshold from the target energy, the server modifies dish candidate information or serving amount information. The server applies a correction algorithm implemented as a non-trivial optimization process, for example, a multi-objective heuristic that balances calorie targets, macronutrient ratios, and ingredient availability. The server may iteratively replace specific dishes with alternative dishes, or adjust serving sizes, based on precomputed nutrient profiles and user preferences. Because the server performs this correction at the structured data level rather than relying solely on new natural-language generation, the server improves convergence speed and ensures numerical accuracy.

The server thereby generates corrected meal plan information. The corrected meal plan information includes, for each day and meal, dish identifiers and serving amounts that are consistent with the nutritional condition information. This corrected meal plan information is stored in association with the user identifier for later retrieval and display by the terminal.

The server calculates required component amount information for the corrected meal plan information. The server determines, for each component, the total quantity required over the planning period by summing serving-level requirements across all dishes and all days. The server then accesses user inventory information indicating current quantities of components the user already possesses. By subtracting inventory quantities from required quantities, the server computes shortage component information, including shortage quantities for each component. The server organizes this shortage component information into shopping list information, sorted and grouped according to categories such as product type or storage requirements. This detailed component-level calculation reduces over-ordering and under-ordering and contributes to reduction of food waste and unnecessary network traffic for repeated queries and corrections.

The server converts the shortage component information into order information formatted for an external provision service. The server maps internal component identifiers and quantities into standardized product codes and packaging units defined by the external service. The server then constructs structured order messages, for example, using a defined schema such as a JSON-based or XML-based schema, and includes delivery address and scheduling information associated with the user. The server may also apply optimization logic to combine orders across multiple meals or days to minimize delivery costs and reduce network transactions. By generating machine-ready order information directly from normalized component information, the server eliminates the need for manual interpretation and reduces the risk of transcription errors.

The terminal displays the corrected meal plan information and the shopping list information using a graphical user interface. The terminal may show, for each day, a list of dishes and nutritional summaries derived from the server's calculations. The terminal may also present interactive controls that permit the user to adjust preferences, record changes in inventory, or confirm orders. When the user performs such interactions, the terminal sends updated information back to the server for further processing. This continuous feedback loop enables the server to maintain synchronized user inventory information and continuously optimize meal plans.

In some embodiments, the server acquires emotional state information as part of the user attribute information. The server may receive emotional state information from explicit user input, from sensor-based estimations, or from historical usage patterns. The server then incorporates the emotional state information into the prompt sentence and includes features such as “stress reduction,” “comfort food,” or “celebratory mood.” For example, the server may generate a prompt sentence such as:

“Generate a 3-day dinner menu for a household of four that supports stress reduction and a relaxed mood. The target energy intake is 2000 kilocalories per person per day. Avoid peanuts and shellfish, and propose dishes that are easy to digest and quick to prepare. Output a list of dishes for each day with short descriptions.”

By encoding emotional state information in the prompt sentence and by maintaining it as a structured field associated with the meal plan information, the server can perform preferential selection of components associated with certain emotional effects, such as warm soups, lightly seasoned dishes, or shared platters. The server stores associations between emotional state categories and component categories in the nutrition information storage device and uses these associations as additional constraints or biases in its dish selection and correction algorithms. This produces a technically distinct data flow compared to conventional systems that treat emotional aspects only as high-level labels.

From a computer-technology perspective, the described architecture provides multiple improvements beyond simple automation of human tasks. The server transforms unstructured generative text into normalized identifiers and numeric attributes, allowing the server to perform precise nutritional calculations and inventory computations that are not feasible with purely manual processes or simple rule-based systems. By designing the prompt sentence generation and parsing pipeline around structured templates, token-level processing, and similarity mapping, the server reduces ambiguity and error in the generative AI output, which improves accuracy and reduces the need for redundant recomputation. In addition, by combining generative AI-based dish suggestion with deterministic nutritional verification and optimization, the server ensures that the final corrected meal plan information satisfies strict numerical constraints, which is a technical effect in terms of data consistency and correctness.

The server also improves computational efficiency by reusing canonical dish and component records and by caching nutritional attribute aggregates. When the server detects that the same dish appears across multiple user meal plans, the server can reuse precomputed nutritional profiles and component requirements, thereby reducing repeated database queries and arithmetic operations. This caching strategy reduces processor load and storage access frequency, resulting in improved throughput under high user volumes. Furthermore, by aggregating shortage component information across multiple orders and performing batch conversion into order information, the server can reduce network communication overhead with the external provision service.

The generative AI model itself improves the operation of the server beyond conventional recommendation engines by enabling the server to generate diverse yet constrained meal plans conditioned on rich user attribute information and nutritional condition information.

The model's internal representation of language and culinary concepts allows the server to explore a larger space of potential dish combinations while still meeting structured constraints enforced by the subsequent verification and correction stages. The server thus uses the generative AI model not merely as a content generator but as a component of a specialized computational pipeline in which the generative stage is tightly coupled with numeric validation and optimization. This coupling leads to improved quality and variety of recommendations while preserving computational tractability.

In various alternative embodiments, the server may employ different types of generative AI models, including recurrent neural networks, encoder-decoder architectures, or hybrid models combining rule-based components with neural components. The server may adjust hyperparameters such as model size, number of attention heads, and generation temperature to trade off between creativity and constraint satisfaction. The server may also integrate reinforcement learning for fine-tuning, where human or simulated feedback on generated menus is used to adjust the model parameters via reward signals, thereby optimizing for user satisfaction while still respecting nutritional constraints.

The described system is not limited to any particular hardware or software platform. The server may be implemented on a cloud computing infrastructure, a dedicated on-premises server, or a hybrid configuration. The terminals may be smartphones, tablet computers, personal computers, or other network-connected devices. The nutrition information storage device may be implemented using any suitable database technology, such as a relational database or a key-value store, provided that it supports efficient retrieval of component information based on dish identifiers and categories.

By combining structured prompt sentence generation, neural network-based generative modeling, deterministic parsing and normalization, quantitative nutritional and inventory computation, and automated order information generation, the server achieves technical effects including improved precision of nutritional compliance, reduced manual data entry and correction, enhanced reuse of computed data, reduced network traffic to external services, and improved scalability for large user populations. The architecture and processing described herein thus constitute a specific and concrete implementation of computer technology that improves the functioning of the overall meal planning and ingredient management system.

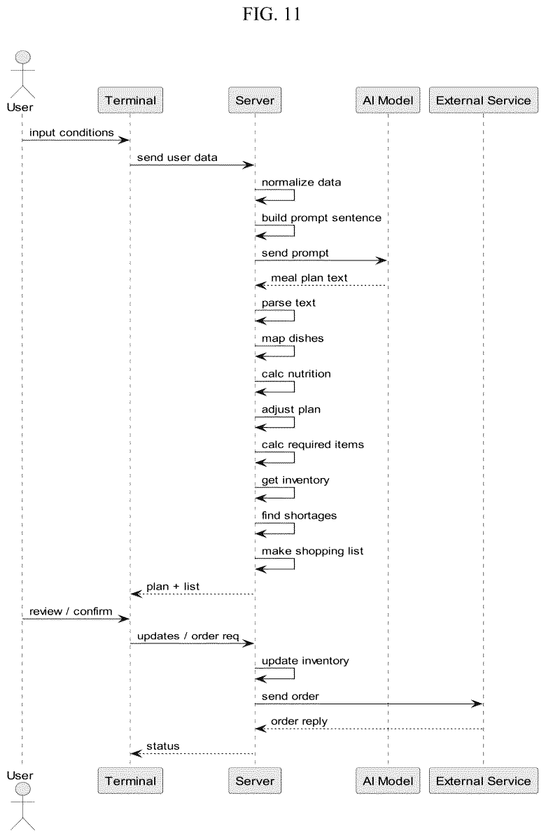

The following describes the processing flow using FIG. 11.

### Step 1:

User operates the terminal to start a meal-planning session and to input user attribute information and nutritional condition information.

User views an input screen on the terminal that includes fields for family composition, dietary preferences, allergy information, emotional state, target daily energy, and target nutrients.

User enters, for example, “family of four, two adults and two children, 2000 kilocalories per person per day, high protein, low sugar, avoid peanuts and shellfish, stressed mood.”

Terminal receives these values as input, validates formats (for example, checks numeric ranges and mandatory fields), converts them into internal structured variables, and outputs a structured request message containing user attribute information and nutritional condition information.

Terminal transmits this structured request message to the server via a network connection using a defined application protocol.

### Step 2:

Server receives the structured request message from the terminal and stores normalized user attribute information and nutritional condition information.

Server parses the input message, extracts fields such as family size, age groups, allergy list, emotional state, target energy, and nutrient constraints, and converts them into normalized categories and numeric values.

Server performs data processing by mapping free-text preference and emotional state labels to predefined internal codes using look-up tables.

Server writes the normalized user attribute information and nutritional condition information into persistent storage, such as a database table, and outputs a normalized user profile record and a normalized nutritional condition record as internal data structures.

### Step 3:

Server generates a prompt sentence for the generative AI model based on the normalized user attribute information and the nutritional condition information.

Server receives, as input, the normalized user profile record and the normalized nutritional condition record, and applies a prompt-template generation algorithm.

Server concatenates template phrases with parameter values, such as family composition, target calories, nutrient focus, allergy list, and emotional state, to construct a coherent natural-language prompt.

Server performs string assembly and tokenization, and outputs a prompt sentence such as “Generate a nutritionally balanced 7-day dinner menu for a household of four, including two adults and two children. The target energy intake is 2000 kilocalories per person per day.

Emphasize high protein and low sugar intake, and strictly avoid peanuts and shellfish. The household is currently under stress, so propose dishes that support relaxation and are easy to prepare. Output the menu as a day-by-day list with dish names and brief descriptions.”

### Step 4:

Server sends the prompt sentence to the generative AI model and obtains free-form meal plan text.

Server provides the prompt sentence as input to a generative AI model interface, either locally or via a model server, by converting the text into tokens and packing them into a model request structure.

Server triggers execution of the neural network model, which performs attention-based computations over the prompt tokens and generates a sequence of output tokens.

Server decodes the output tokens into a natural-language string representing generated meal plan information, and outputs this free-form meal plan text for downstream processing.

### Step 5:

Server parses the free-form meal plan text into structured meal plan information.

Server receives, as input, the generated text that contains day labels, meal types, and dish names.

Server applies a parsing algorithm that uses regular-expression patterns, line-by-line segmentation, and keyword detection to identify day boundaries (for example, “Day 1,” “Day 2”), meal types (for example, “Breakfast,” “Dinner”), and candidate dish names.

Server transforms the unstructured text into a structured representation, for example, a list of records each containing a day index, meal type, and dish name string, and outputs this preliminary structured meal plan information.

### Step 6:

Server maps dish name strings to canonical dish information stored in the nutrition information storage device.

Server receives, as input, the preliminary structured meal plan information containing dish name strings.

Server performs data processing by normalizing dish names (lowercasing, removing punctuation, standardizing synonyms) and then executing similarity matching against stored dish records.

Server computes similarity scores using a combined metric that includes string edit distance, token overlap, and, optionally, vector similarity from precomputed dish embeddings.

Server selects, for each dish name string, a canonical dish identifier that meets a similarity threshold, and outputs updated meal plan information in which each dish entry includes a canonical dish identifier as well as the original name.

### Step 7:

Server retrieves component information and nutritional attributes for each canonical dish and computes nutritional value information and energy amount information.

Server receives, as input, the updated meal plan information containing canonical dish identifiers and serving assumptions per user or per meal.

Server issues database queries to the nutrition information storage device to obtain component lists and per-unit nutritional values for each dish's components.

Server multiplies per-unit nutritional values by serving quantities to calculate per-dish totals, and then aggregates these per-dish totals across all meals and days to compute daily and period-wide nutritional value information and energy amount information.

Server outputs structured nutritional summaries that include, for each day and for the entire period, values such as total energy, total protein, total fat, and other nutrient totals.

### Step 8:

Server compares the computed nutritional values with the nutritional condition information and generates corrected meal plan information.

Server receives, as input, the nutritional summaries and the stored nutritional condition information for the user.

Server performs data comparison by calculating deviations between computed nutrient values and target ranges, and flags nutrients where the deviation exceeds a predefined threshold.

Server then executes a correction algorithm that may, for example, decrease serving sizes of high-calorie dishes, increase servings of high-protein dishes, or replace certain dishes with alternative dishes that have more favorable nutrient profiles.

Server updates the structured meal plan information to reflect these changes and recalculates nutritional summaries as needed until deviations fall within acceptable limits.

Server outputs corrected meal plan information that includes dish identifiers, serving amounts, and updated nutritional summaries.

### Step 9:

Server calculates required component amount information for the corrected meal plan information.

Server receives, as input, the corrected meal plan information including dish identifiers and final serving amounts.

Server aggregates, for each component, the total quantity required over all occurrences of the component in the meal plan by summing the per-dish component amounts multiplied by the number of servings.

Server performs numeric accumulation for each component identifier and outputs required component amount information listing each component and its total required quantity and unit for the planning period.

### Step 10:

Server obtains user inventory information and identifies shortage component information.

Server retrieves current user inventory information from persistent storage, including recorded quantities and units for each component the user currently possesses.

Server applies data processing by aligning component identifiers between the required component amount information and the inventory information.

Server computes, for each component, the difference between required quantity and inventory quantity, and identifies those components for which the difference is positive.

Server outputs shortage component information that includes each component with a shortage and the corresponding shortage quantity and unit.

### Step 11:

Server generates shopping list information and order information based on the shortage component information.

Server receives, as input, the shortage component information and optional user preferences for shopping or delivery.

Server constructs a shopping list by formatting each shortage component into a human-readable entry that includes the component name, shortage quantity, and unit, and optionally grouping entries by category.

Server, in parallel, maps internal component identifiers to product identifiers used by an external provision service and constructs structured order information messages that include product identifiers, quantities, delivery address, and scheduling parameters.

Server outputs shopping list information for display on the terminal and order information for potential transmission to the external provision service.

### Step 12:

Server transmits corrected meal plan information and shopping list information to the terminal.

Server packages the corrected meal plan information and shopping list information into response messages formatted according to a defined interface specification.

Server sends these messages over the network to the terminal.

Terminal receives the messages, parses the included data structures, and renders user interface screens that show, for each day, the planned meals and their nutritional summaries, and, in a separate view, the shopping list with component names and required quantities.

Terminal outputs a graphical representation that allows the user to visually confirm and interact with the results of the server's computations.

### Step 13:

User reviews the corrected meal plan information and shopping list information on the terminal and optionally confirms or modifies them.

User examines, as input, the displayed menus and shopping list and may perform actions such as accepting the plan, changing certain dishes, or indicating that some items are already available.

Terminal captures user actions, such as tapping on items, adjusting sliders for portion sizes, or toggling checkboxes for items in stock, and converts these interactions into update messages.

Terminal transmits the update messages back to the server as input for further processing, and outputs updated display states that reflect the user's adjustments.

### Step 14:

Server updates user inventory information and, when requested, sends order information to an external provision service.

Server receives, as input, update messages from the terminal indicating purchased items, consumed items, or manual inventory corrections.

Server applies data processing by adjusting stored inventory quantities according to the reported changes, thereby updating the user inventory information in the database.

Server, upon explicit user confirmation of an order, transmits the previously generated order information to the external provision service using a defined network protocol, and may receive confirmation responses.

Server outputs an updated system state in which inventory records, meal plans, and external orders remain synchronized, thereby enabling accurate future calculations and reduced redundant processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional computer-implemented meal recommendation and grocery ordering systems, the underlying computation is typically divided into isolated modules: a rule-based or static recommendation engine for nutrition, a separate inventory management module, and a simple interface to a product ordering service. These systems generally apply fixed templates or heuristic rules to propose meals, do not tightly integrate machine-learned nutritional optimization with natural-language menu generation, and treat user interaction as a thin presentation layer that merely displays precomputed results. As a consequence, existing systems exhibit several technical limitations from the perspective of computer technology.

First, conventional systems are unable to efficiently process heterogeneous user data, such as structured health and lifestyle parameters combined with unstructured natural-language preferences, in a unified computation pipeline. The lack of a coordinated processing framework causes repeated data transformations between modules, redundant computation, and inconsistent state between nutrition planning, inventory records, and order generation.

This fragmentation increases processor load and memory usage and can lead to suboptimal resource utilization in the information processing apparatus.

Second, traditional architectures do not exploit a trained inference model for numerical nutrition calculation in combination with a generative AI model for menu textualization in a coordinated manner. Nutritional targets, constraints, and inventory states are often not reflected explicitly in the prompts issued to a generative model. As a result, menu texts may be inconsistent with computed nutrition plans or current inventory, requiring additional manual correction or post-filtering. This inconsistency generates unnecessary computation cycles, network traffic, and storage operations, degrading system efficiency.

Third, inventory comparison and automatic ordering are frequently implemented as batch processes that are loosely coupled to the meal recommendation logic. Such implementations recompute ingredient requirements from scratch for each update, without leveraging the structured output of a numerical nutrition model and the structured mapping from meal plans to ingredient requirements. This leads to redundant database accesses, inefficient query patterns, and delays in synchronizing meal plans with actual ingredient availability, thereby impairing responsiveness and scalability of the system.

Fourth, user interaction with conventional systems is often limited to static screens that do not drive adaptive recomputation in the backend. Emotional state information, dynamic lifestyle changes, and revised natural-language prompts are either not captured at all or are handled in an ad hoc manner outside the core computation pipeline. Consequently, the system cannot dynamically update meal plans and ingredient orders in real time based on such context, and the processing apparatus may waste computational resources by recomputing large portions of the plan instead of incrementally updating selected components.

Moreover, existing systems do not provide a unified dataflow in which user attribute information, lifestyle information, inventory information, menu text, and order information are maintained in a consistent relational structure that can be efficiently used for both inference and interaction. This lack of unified data modeling forces duplicated storage, complex synchronization mechanisms, and error-prone glue code between separate services, which collectively deteriorate system maintainability and performance.

Accordingly, there is a need for a computer-implemented system that improves the way an information processing apparatus acquires and represents user attribute information and lifestyle information, invokes a trained inference model for nutrition calculation, constructs and issues optimized prompt sentences to a generative AI model, maps numerical meal plan outputs to ingredient requirements and inventory records, and generates order information in a coordinated and resource-efficient manner. There is also a need for a system that can dynamically update meal plan information and menu information in response to changes in emotional state information and user interaction, while reducing redundant processing, network communication, and storage operations. The technical problem to be solved is therefore to improve the internal operation of the information processing apparatus specifically the efficiency, consistency, and integration of data processing across nutrition planning, natural-language generation, inventory management, and automated ordering rather than merely automating a human workflow.

The specific processing by the specific processing unit 290 of the data processing device 12 in Application Example 1 is realized by the following means.

The present invention provides a server comprising a processor and a memory storing instructions which, when executed by the processor, cause the server to acquire user attribute information and lifestyle information from a client apparatus over a communication network; to perform numerical computation processing by inputting the user attribute information and the lifestyle information into a trained inference model that executes predetermined nutrition calculation processing, thereby generating meal plan information including a plurality of meal configuration information in which nutrient allocation and energy intake are defined; to construct a prompt sentence in a natural language on the basis of the meal plan information and the user attribute information, the prompt sentence including nutritional conditions and constraint conditions derived from the meal plan information, and to transmit the prompt sentence to a generative AI model and receive, from the generative AI model, menu information represented in the natural language, and to store the meal plan information and the menu information in association with each other in a storage apparatus; to associate each piece of the meal configuration information with preparation information and ingredient information stored in a preparation information storage area, and to calculate, using arithmetic processing, types and amounts of ingredients required for an entirety of the meal plan information; to compare the calculated types and amounts of the ingredients with inventory information stored in an inventory information storage area that stores inventory information of ingredients held by a user, and to identify types and amounts of ingredients that are in shortage; to generate order information for an external goods providing service on the basis of the identified types and amounts of ingredients in shortage and to transmit the order information via the communication network to automatically execute order processing for the ingredients; and to generate screen data by converting at least a portion of the meal plan information, the menu information, the identified types and amounts of ingredients in shortage, and the order information into a format displayable on a display apparatus of the client apparatus, and to perform user interaction processing by transmitting the screen data to the client apparatus and receiving operation information for confirming or changing the order processing. This enables an information processing apparatus to internally integrate numerical nutrition computation and natural-language menu generation, to maintain a consistent dataflow from user attribute acquisition through inventory comparison and external ordering, to reduce redundant computation and database access when updating meal plans and associated orders, and to dynamically adapt meal planning and ordering operations in response to changing user context and interaction, thereby improving the overall efficiency, responsiveness, and reliability of computer-based meal planning and ingredient ordering processes.

The term “user attribute information” refers to information representing characteristics of a user, including, for example, age, sex, body measurements, family composition, activity level, dietary preferences, allergies, and emotional state, which can be processed in structured or semi-structured form by an information processing apparatus.

The term “lifestyle information” refers to information representing daily habits and conditions of a user, including, for example, eating patterns, work schedule, exercise frequency, sleep patterns, and typical meal times, which can influence nutritional requirements and meal planning by a computing system.

The term “trained inference model” refers to a computational model, such as a machine learning model or statistical model, that has been trained in advance using training data and that performs numerical or logical inference on input data to produce output values without further training during normal operation.

The term “nutrition calculation processing” refers to processing in which a computing apparatus calculates nutritional targets, allocations, or constraints, such as energy intake, macronutrient distribution, and micronutrient amounts, based on user attribute information and lifestyle information.

The term “meal plan information” refers to structured data generated by a computing apparatus that defines one or more meals over a period of time, including, for each meal, information such as meal timing, nutrient allocation, and target energy intake.

The term “meal configuration information” refers to information representing a unit meal within the meal plan information, including attributes such as meal type, associated nutrient amounts, target energy value, and serving count.

The term “nutrient allocation” refers to information specifying quantitative or proportional distributions of one or more nutrients, such as proteins, fats, carbohydrates, vitamins, or minerals, within a meal or meal plan.

The term “energy intake” refers to information indicating an amount of dietary energy, such as total calories or kilojoules, that is to be consumed during a specified meal or period, as computed or constrained by a computing apparatus.

The term “prompt sentence” refers to a text string in a natural language that is constructed or selected by a computing apparatus and provided as input to a generative AI model in order to condition or control the generation of output content.

The term “generative AI model” refers to a computational model, such as a generative machine learning model or large language model, that generates new data, including natural-language text, on the basis of input data such as prompt sentences and contextual information.

The term “menu information” refers to data representing a collection of meals or dishes in a human-readable form, typically expressed in natural-language text, and including, for example, dish names, descriptions, and optionally approximate nutritional or serving information.

The term “preparation information” refers to information describing how a meal or dish is prepared, including, for example, cooking steps, required tools, processing methods, and associations between dishes and ingredients.

The term “ingredient information” refers to information describing materials used to prepare meals, including, for example, ingredient names, categories, unit types, and relationships to nutritional values.

The term “preparation information storage area” refers to a logical or physical storage region, such as a database or memory area, in which preparation information and associated ingredient information are stored for access by a computing apparatus.

The term “inventory information storage area” refers to a logical or physical storage region in which inventory information for ingredients held by a user is stored, including, for example, current stock quantities, unit types, and optionally expiration-related data.

The term “inventory information” refers to information representing the state of ingredients or materials available to a user, including types of ingredients, quantities, units of measure, and optionally storage locations and expiration dates.

The term “types and amounts of ingredients” refers to data specifying individual ingredient identities and their corresponding quantitative values, such as weights, volumes, or counts, required or available for meal preparation.

The term “ingredients in shortage” refers to ingredients for which required amounts determined from the meal plan information exceed available amounts indicated by the inventory information, such that additional acquisition is necessary.

The term “order information” refers to data generated by a computing apparatus for requesting provision of goods from an external service, including identifiers of items to be ordered, quantities, user or delivery information, and optionally scheduling or payment-related parameters.

The term “external goods providing service” refers to an external system or service, such as an online commerce service or delivery service, that receives order information and supplies physical goods, including ingredients, to a user.

The term “communication network” refers to any wired or wireless data communication infrastructure that enables data transmission between a server, client apparatus, and external services, including, for example, local area networks, wide area networks, and public networks.

The term “screen information” refers to data defining a visual layout and content to be displayed on a display apparatus, including, for example, text, graphical elements, and interactive controls representing meal plans, menus, inventory states, and order options.

The term “user interaction processing” refers to processing in which a computing apparatus generates screen information for presentation to a user, receives operation information or input actions from the user, and updates internal data or external communications based on the received input.

The term “operation information” refers to information representing user actions or selections input through a user interface, including, for example, confirmations, modifications, selections of items, or parameter changes relating to meal plans or orders.

The term “client apparatus” refers to an electronic device operated by a user, such as a smartphone, tablet, personal computer, or other terminal, that communicates with a server and presents screen information to the user.

The term “display apparatus” refers to a hardware component capable of visually presenting information to a user, such as a liquid-crystal display, organic light-emitting diode display, or other graphical display device.

The term “emotional state information” refers to information representing a user's psychological or emotional condition, such as stress levels, mood categories, or self-reported feelings, which can be used as an input parameter for computation in the system.

The term “activity level information” refers to information indicating the degree or pattern of physical activity of a user, such as sedentary, moderate, or high activity, which may affect nutritional calculations.

The term “body information” refers to physical characteristics of a user, including, for example, height, weight, body mass index, or other biometric or anthropometric parameters relevant to nutritional computation.

The term “target nutrient information” refers to information specifying desired amounts or ranges of one or more nutrients to be consumed by a user over a particular period, used as constraints or objectives in nutrition calculation processing.

The term “target energy intake information” refers to information specifying desired levels of energy consumption, such as daily or per-meal calorie targets, used as constraints or objectives in nutrition calculation processing.

The term “constraint conditions” refers to conditions that limit or restrict the space of allowable solutions in computation, including, for example, dietary restrictions, allergy exclusions, maximum or minimum nutrient levels, and timing restrictions applied during meal planning or generative processing.

The term “selection priority” refers to a weighting or ordering measure used by a computing apparatus to determine which preparation information or ingredient information should be preferentially selected when multiple candidates satisfy given constraints.

The term “information processing apparatus” refers to one or more computing devices, including hardware and software components, that execute programs to perform data acquisition, calculation, storage, communication, and control in implementing the described functions.

The term “server” refers to an information processing apparatus configured to provide computational, storage, and communication services to one or more client apparatuses over a communication network.

In one embodiment, a server implements the claimed system using a general-purpose computing platform configured with a multi-core central processing unit, a graphics processing unit for accelerating tensor operations, a volatile memory, a non-volatile storage device such as a solid-state drive, and a network interface conforming to an Internet protocol.

The server executes an operating system such as a Unix-like operating system and runs an application stack including a web framework, a relational database management system, and a machine learning execution environment.

The server executes application logic written in a high-level programming language that interacts with a machine learning library, such as a tensor computation framework, to implement a trained inference model for nutrition calculation. The server stores user attribute information, lifestyle information, preparation information, ingredient information, inventory information, and order information in one or more relational databases, such as a structured query language database, with normalized tables and indexed columns to support efficient joins and queries.

The terminal is, for example, a smartphone, a tablet, or a personal computer comprising a processor, a memory, a touch-sensitive display, and a wireless or wired communication interface. The terminal executes a browser or a native application that communicates with the server using hypertext transfer protocols over a secure channel. The terminal presents graphical user interface screens that display input fields, menus, and confirmation dialogs, and that accept user interactions such as touch events, keyboard input, and pointer operations.

The user operates the terminal to provide user attribute information and lifestyle information.

The user may input age, sex, height, weight, family composition, dietary preferences, allergy constraints, activity level, and emotional state selections. The user may further input a prompt sentence in natural language. For example, the user may input:

“Please propose a 5-day meal plan for a 32-year-old male with moderate exercise, 2000 kcal per day, high protein, low sugar, suitable for a family of three, and free from nuts and shellfish.”

The terminal converts the user's input into structured data, such as key-value pairs, and transmits the structured data together with the raw text of the prompt sentence to the server via the communication network.

The server stores the received user attribute information and lifestyle information in dedicated tables, for example, a user profile table, a household table, and a health profile table, each with columns for age, sex, body measurements, family size, activity level, preference codes, allergy codes, and emotional state codes. The server uses foreign keys to link these tables to a user identifier, so that subsequent processing can access all relevant attributes for a particular user with a single indexed query. This explicit data modeling improves data access patterns inside the server and reduces redundant loading of overlapping information.

The server preprocesses the stored information to generate feature vectors for the trained inference model. The server encodes categorical attributes, such as sex, activity level, and emotional state, by constructing one-hot vectors or embedding indices. The server normalizes continuous attributes, such as age, height, weight, and target energy intake, by subtracting mean values and dividing by standard deviations that were determined during model training.

The server concatenates the encoded attributes into a fixed-length numerical vector, which the server stores as a binary blob or as a separate feature table. By maintaining a consistent feature representation, the server reduces the computational overhead for repeated feature extraction when the same user's data are reused.

In one embodiment, the server implements the trained inference model as a feed-forward neural network constructed using a tensor computation framework. The neural network comprises, for example, an input layer receiving the feature vector, multiple fully connected hidden layers with rectified linear unit activations, and an output layer that produces target values for nutrient allocation and energy intake per meal. The hidden layers may include batch normalization and dropout components to improve training stability and generalization.

The network parameters (weights and biases) are stored in a model file that the server loads into memory at startup time.

The server trains the neural network offline using a training dataset of historical meal plans, nutritional targets, and user profiles. During training, the server applies a supervised learning procedure using a loss function that includes, for example, a mean squared error term between predicted nutrient allocations and reference allocations, and a penalty term for violating upper or lower bounds on energy intake or specific nutrients. The server performs gradient-based optimization, such as stochastic gradient descent or an adaptive method, to update the neural network weights. The server may apply data augmentation by perturbing target calories within a narrow range or by simulating variations in activity levels, thereby increasing the robustness of the inference model. After convergence, the server freezes the weights and deploys the network as the trained inference model.

During operation, the server forwards the preprocessed feature vector to the neural network and performs tensor operations on the central processing unit and the graphics processing unit. The server obtains, as output, numerical values specifying per-meal energy intake, per-meal macronutrient amounts, and, optionally, target ranges for specific micronutrients. The server transforms these outputs into meal plan information, which is a structured data object comprising multiple records, each record corresponding to a meal configuration information unit. Each meal configuration information unit includes fields for meal type (for example, breakfast, lunch, dinner), target energy value, target protein, carbohydrate, and fat amounts, and applicability to specific household members.

The server persists the meal plan information in the relational database using normalized tables. The server stores one table for high-level meal plan metadata, including user identifier and planning horizon, and another table for individual meal entries with foreign keys linking back to the plan metadata. This structure permits incremental updates of particular meals without reconstructing the entire plan and allows efficient queries, such as retrieving all meals scheduled for a specific day.

The server constructs a prompt sentence for a generative AI model by combining the user's original prompt sentence with structured constraints derived from the meal plan information.

For example, the server may append explicit numerical constraints and restrictions to the original text:

“Generate a 5-day meal plan for a 32-year-old male with moderate exercise, for a family of three. Each day must be around 2000 kcal total for the user, with at least 100 g protein and limited simple sugars. Exclude all nuts and shellfish. Provide breakfast, lunch, and dinner for each day, with approximate calories and protein amounts per meal.”

The server formats the prompt sentence as part of a request payload to the generative AI model. In one embodiment, the generative AI model is a transformer-based language model hosted on a remote computing system. The server includes, in the request, system-level instructions, the derived constraints, and the user's natural-language preferences. The server selects model parameters, such as sampling temperature and maximum token count, in order to balance diversity and adherence to constraints.

The server transmits the prompt sentence to the generative AI model over the communication network and receives a response comprising generated menu information in natural-language text. The menu information contains a sequence of days and, for each day, meals with dish names, brief descriptions, and approximate calorie and protein estimates. The server analyzes the received text using pattern-matching routines and tokenization to identify day labels, meal labels, and dish descriptions. The server then maps the identified meals to the corresponding meal configuration information units based on meal type and approximate calorie ranges.

The server accesses preparation information and ingredient information stored in a preparation information storage area. In one embodiment, the preparation information is implemented as a set of recipe records in the relational database, each record including a dish name, a list of steps, and a link to a list of ingredients and base quantities. The ingredient information table includes ingredient identifiers, category codes, density or conversion factors, and nutritional profiles.

The server resolves each dish name in the menu information to a recipe record using a combination of exact matching and approximate text matching. The server then calculates the required ingredients for each meal by scaling the base ingredient quantities according to the target energy intake and the number of people to be served. The server aggregates the ingredient requirements across all meals within the meal plan to compute total required amounts per ingredient. The server performs these calculations using vectorized arithmetic operations optimized by the processor, which reduces the number of loops and improves execution speed compared to naive computation.

The server retrieves inventory information from an inventory information storage area that maintains, for each ingredient, a current stock quantity and an optional expiration indicator.

The server loads the inventory information into memory as an associative data structure keyed by ingredient identifier. The server compares the aggregated ingredient requirements with the in-memory inventory structure and determines, for each ingredient, whether the available quantity is sufficient. The server computes differences where the required amount exceeds the available amount and flags these as ingredients in shortage. The server stores the computed shortages as structured records linked to the relevant meal plan.

The server generates order information based on the identified shortages. The server may apply rule-based logic or optimization routines to consolidate ingredient purchases, select preferred suppliers, and choose package sizes. For instance, the server may select a single package of a standardized size that covers the required deficit while minimizing over-purchasing. The server constructs order information including item identifiers, quantities, user delivery address, and time preferences, and transmits this order information to an external goods providing service using a programmable interface. The external service returns confirmation identifiers and status codes, which the server stores with the order records.

The server prepares screen information for the terminal by assembling the meal plan information, the menu information, the ingredient shortage list, and the order information into a hierarchical representation suitable for rendering. The server may serialize this representation as structured data or pre-rendered markup. The terminal receives the screen information and displays, on its display device, screens that show the day-by-day meal plan, dish names, nutritional summaries, inventory status, and the proposed orders.

The user views the displayed screens and may choose to confirm or modify the proposed orders. The user may, for example, deselect specific ingredients, adjust quantities, or revise preferences that were used in the nutrition calculation. The terminal captures these user interactions and encodes them as operation information that is transmitted to the server. The server updates the meal plan information, menu information, and order information based on the operation information, without recomputing unrelated portions of the plan. This incremental update capability reduces redundant processing and database access.

In another embodiment, the server uses emotional state information as part of the feature vector for the trained inference model and as a modifier for recipe selection. For example, if the emotional state indicates high stress, the server may increase the selection priority of recipes that historical data correlate with stress reduction, such as warm soups or familiar comfort dishes, while still honoring nutritional constraints. The server implements selection priority as numeric weights in a recipe ranking algorithm, and the server adjusts these weights in response to emotional state codes. By applying these weights during the mapping from meal configuration information to recipe records, the server achieves more precise control over both nutritional and emotional objectives.

In a further embodiment, the generative AI model structure and parameters may be specialized for dietary text generation. The model may be fine-tuned on a corpus of annotated menus where each text sample is associated with numerical nutrient summaries. During fine-tuning, the server uses a loss function that penalizes deviations between nutrient indications extracted from generated text and target nutrient values from the training samples. This encourages the language model to produce descriptions that are consistent with numerical nutrition plans and reduces post-processing corrections.

The described configuration improves computer technology itself by optimizing internal data flows and reducing unnecessary computation. By representing user attribute information, lifestyle information, meal plan information, menu information, inventory information, and order information in well-defined relational and in-memory data structures, the server can use indexed queries and incremental updates instead of full recomputation. By combining a trained inference model for numerical nutrition calculation with a generative AI model under explicit constraint control via the prompt sentence, the server reduces inconsistencies between numeric plans and textual menus, lowering the need for corrective processing.

Furthermore, by performing efficient aggregation and comparison operations on the server side, the system reduces data transmission volume over the communication network, because the terminal receives only the finalized plan and order summaries, rather than raw intermediate data.

These technical effects faster computation due to optimized vectorized arithmetic and GPU acceleration, improved accuracy of nutritional planning due to trained model inference, reduced database load through normalized schema and incremental updates, and reduced communication load by transmitting compact summaries are the result of specific architectural and algorithmic choices implemented in the server and are not merely an automation of human meal planning and ordering. The server performs operations that an unaided human cannot practically perform at scale, such as rapid evaluation of many possible meal compositions under multi-dimensional constraints, real-time synchronization with inventory records across multiple data stores, and dynamic adjustment of selection priorities in response to emotional state and updated prompt sentences.

Various alternative embodiments are possible. In one variation, the trained inference model may use a recurrent neural network or a graph neural network instead of a purely feed-forward architecture, enabling the model to capture dependencies across meals over several days. In another variation, the inventory comparison may incorporate expiration dates as an additional constraint by preferentially consuming ingredients that are closer to expiration, thereby requiring the server to solve a constrained optimization problem during meal assignment. In yet another variation, the generative AI model may be hosted locally on the same physical server as the inference model, in which case the server communicates with the generative model through an internal application programming interface rather than a remote network call, further reducing latency.

The terminal and server may also cooperate to adjust computational load distribution. For example, the terminal may perform preliminary validation of user input and simple calculations, such as body mass index computation, while the server performs heavier tensor operations and inventory optimization. This distribution further improves overall responsiveness and conserves network bandwidth.

Through the above-described configurations and variations, the server, the terminal, and the user interactions collectively implement the claimed system in a manner that enables practical deployment, technical performance improvements, and reproducible operation, thereby providing an embodiment that allows a person skilled in the art to put the invention into practice.

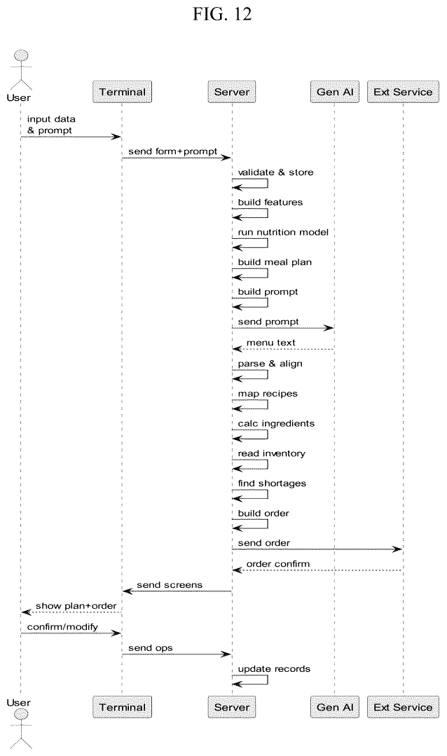

The following describes the processing flow using FIG. 12.

### Step 1:

The terminal displays an input screen for user attribute information and lifestyle information.

The terminal receives, as input, interaction events from the user, including touches or keystrokes, and renders text fields, drop-down lists, and selection controls for age, sex, height, weight, family composition, dietary preferences, allergy constraints, activity level, emotional state, and a free-text area for a prompt sentence to a generative AI model.

The terminal converts the user's interaction events into structured form data and a raw text string for the prompt sentence as output, ready to be transmitted to the server.

### Step 2:

The user inputs user attribute information, lifestyle information, and a prompt sentence using the terminal.

The user provides, as input, values such as “32”, “male”, “moderate exercise”, “family of three”, “no nuts or shellfish”, “2000 kcal per day”, and a natural-language prompt sentence such as “Please propose a 5-day meal plan for a 32-year-old male with moderate exercise, 2000 kcal per day, high protein, low sugar, suitable for a family of three, and free from nuts and shellfish.”

The user causes the terminal to output a completed set of form data and the prompt sentence by activating a submission control, such as a button or menu command.

### Step 3:

The terminal transmits the structured input data and the prompt sentence to the server.

The terminal takes, as input, the completed form data and prompt sentence from Step 2 and serializes them into a request payload, for example, a JSON object containing key-value pairs for each attribute and a text field for the prompt sentence.

The terminal performs data conversion and encapsulates the payload in an HTTP request, then outputs the request over a secure network connection to the server.

### Step 4:

The server receives and validates the input data from the terminal.

The server accepts, as input, the HTTP request containing the structured data and the prompt sentence, parses the request body into internal data structures, and checks that required fields are present, that numerical values (such as age, height, weight, and target calories) are within reasonable ranges, and that categorical values (such as sex and activity level) match predefined enumerations.

The server outputs a validated and sanitized set of user attribute information and lifestyle information, or an error response if validation fails; when validation succeeds, the server also outputs normalized text for the prompt sentence.

### Step 5:

The server stores user attribute information and lifestyle information in a persistent storage.

The server takes, as input, the validated data from Step 4 and maps them to database tables, such as profile tables and household tables, using a relational database management system.

The server performs data insertion or update operations, including generation of primary keys and foreign keys, and outputs stored records that are linked by a user identifier and are retrievable for subsequent computation.

### Step 6:

The server generates feature vectors for nutrition calculation.

The server receives, as input, the stored user attribute information and lifestyle information associated with a user identifier, queries the database to retrieve the relevant records, and loads them into memory.

The server performs data processing, including one-hot encoding of categorical attributes, normalization of continuous attributes, and concatenation into a fixed-length numerical vector, and outputs a feature vector that is suitable as input to a trained inference model.

### Step 7:

The server executes a trained inference model to calculate numerical meal plan targets.

The server takes, as input, the feature vector from Step 6 and feeds it into a trained numerical model, such as a multi-layer neural network executed by a tensor computation framework on a CPU and optionally on a GPU.

The server performs tensor multiplications, activation function evaluations, and other numerical operations defined by the model architecture, and outputs numerical values representing per-meal energy intake, macronutrient amounts, and optional micronutrient ranges that form the basis of meal plan information.

### Step 8:

The server constructs structured meal plan information from the numerical outputs.

The server receives, as input, the per-meal numerical targets from Step 7 and creates meal configuration records for each meal slot, such as breakfast, lunch, and dinner for each day.

The server assigns fields for meal type, target energy, target protein, carbohydrate, fat amounts, and applicable household members, and outputs meal plan information as a structured collection of meal configuration information units.

### Step 9:

The server stores the meal plan information in the database.

The server takes, as input, the structured meal plan information from Step 8 and inserts corresponding records into meal plan tables in the relational database, including a header table for plan metadata and a detail table for individual meals.

The server performs database operations that create and link records using foreign keys, and outputs persistent meal plan records associated with the user identifier and a planning period.

### Step 10:

The server constructs an optimized prompt sentence for the generative AI model.

The server uses, as input, the stored meal plan information from Step 9, the original prompt sentence received in Step 4, and the user attribute information.

The server extracts relevant constraints, such as total daily calories, required protein minimums, excluded ingredients, and family size, and programmatically composes a new prompt sentence by appending explicit numerical constraints and dietary restrictions to the original text. The server outputs an optimized prompt sentence in natural-language text format.

### Step 11:

The server transmits the optimized prompt sentence to a generative AI model and receives menu text.

The server uses, as input, the optimized prompt sentence from Step 10 and parameters such as maximum text length and sampling settings, and constructs a request to a generative AI model, for example, a transformer-based language model accessible via a network interface.

The server sends the prompt sentence over the communication network to the generative AI model, receives generated text that describes a multi-day menu with dish names and descriptions as output, and stores the raw generated menu information in memory or in a text field in the database.

### Step 12:

The server parses and aligns the generated menu information with the meal plan information.

The server takes, as input, the natural-language menu text from Step 11 and the structured meal plan information from Step 9.

The server performs tokenization, pattern matching, and simple parsing rules to identify day labels, meal types, and dish descriptions, then matches each parsed menu entry to a corresponding meal configuration record based on meal type and approximate calorie targets.

The server outputs aligned records in which each meal configuration information unit is associated with a specific dish name and description.

### Step 13:

The server maps menu entries to preparation information and ingredient information.

The server receives, as input, the aligned meal/dish associations from Step 12 and queries the preparation information storage area for recipes that correspond to the dish names.

The server executes exact or approximate string matching and, where multiple candidates are found, applies selection criteria such as category codes and nutritional compatibility. The server outputs a mapping from each meal to a specific recipe identifier and an associated ingredient list.

### Step 14:

The server calculates required ingredient quantities for the entire meal plan.

The server takes, as input, the mapped recipes and ingredient lists from Step 13, as well as serving counts derived from family composition in the user attribute information.

The server multiplies base ingredient quantities by scaling factors corresponding to serving counts and target energy intake per meal and sums quantities for identical ingredients across all meals, performing arithmetic operations to generate aggregated required amounts per ingredient. The server outputs a consolidated list of ingredient types and required amounts.

### Step 15:

The server retrieves and structures inventory information.

The server receives, as input, a user identifier and accesses the inventory information storage area to query records of ingredients held by the user.

The server reads inventory records, including ingredient identifiers, current stock quantities, and optional expiration data, and loads them into an in-memory data structure keyed by ingredient identifier. The server outputs a structured representation of current inventory for subsequent comparison.

### Step 16:

The server compares required ingredient quantities with inventory information to identify shortages.

The server uses, as input, the consolidated required ingredient list from Step 14 and the structured inventory data from Step 15.

The server performs subtraction operations for each ingredient between required quantities and available stock, determines which ingredients have a positive deficit (required greater than available), and records these as ingredients in shortage with calculated deficit amounts.

The server outputs a shortage list comprising ingredient types and shortage quantities.

### Step 17:

The server generates order information for ingredients in shortage.

The server takes, as input, the shortage list from Step 16 and optional supplier preferences and packaging data stored in configuration tables.

The server applies rule-based logic or optimization calculations to select package sizes and suppliers that cover the deficit with minimal surplus, constructs order line items with ingredient identifiers and quantities, and adds user address and delivery preferences. The server outputs order information records ready to be transmitted to an external goods providing service.

### Step 18:

The server transmits order information to an external goods providing service and receives confirmation.

The server uses, as input, the order information from Step 17 and formats it as a request payload conforming to an external service application programming interface.

The server sends the payload over the communication network, receives a response containing order identifiers and status codes as output, and stores these confirmation details in the database linked to the original order records.

### Step 19:

The server constructs screen information for presentation on the terminal.

The server takes, as input, the meal plan information from Step 9, the aligned menu information from Step 12, the shortage list from Step 16, and the order information with confirmation from Step 18.

The server composes a hierarchical data structure representing daily menus, nutritional summaries, ingredient status, and order details, transforms these data into a format suitable for rendering (such as structured markup or serialized objects), and outputs screen information that can be directly consumed by the terminal.

### Step 20:

The terminal receives and renders the screen information for the user.

The terminal uses, as input, the screen information transmitted by the server in Step 19, parses the received data, and maps it to visual components such as lists, tables, and buttons.

The terminal performs drawing operations on the display device to show the multi-day meal plan, dish descriptions, nutritional highlights, ingredient shortages, and order confirmations to the user, and outputs updated graphical screens.

### Step 21:

The user reviews the presented information and provides operation information.

The user uses, as input, the rendered screens and inspects meal plans, inventories, and orders, and may make decisions such as approving the order, modifying a meal, or adjusting constraints.

The user interacts with the terminal through selectable controls, which the terminal converts into operation information indicating actions like confirmation, modification, or cancellation, and the user causes the terminal to output this operation information back to the server.

### Step 22:

The server updates internal records based on the operation information.

The server receives, as input, the operation information from Step 21 and checks the type of operation, such as order confirmation, partial modification, or new constraints.

The server updates the corresponding database records for meal plans, menu associations, inventory projections, and order statuses, and, where necessary, performs incremental recalculations limited to affected meals or ingredients. The server outputs updated stored data that reflect the user's latest choices and are ready for subsequent display or further processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented meal planning and inventory management systems typically rely on static rule engines or manually curated templates. Such systems often treat user attributes, nutritional requirements, energy (calorie) constraints, food preferences, allergies, emotional states, and pantry inventory as loosely connected data sets, processed in separate modules. As a result, conventional architectures suffer from several technical problems in terms of data processing and resource utilization.

First, traditional systems lack a unified mechanism to transform heterogeneous user condition data (including nutritional condition data, energy amount condition data, preference condition data, prohibition condition data, goal condition data, and emotional state data) into a machine-interpretable representation that can drive generation of meal plan data in a flexible and adaptive manner. This leads to fragmented data flows and increased processing overhead, because separate logic must be maintained for each combination of constraints, and system updates often require manual modification of rule sets or templates.

Second, many existing systems are not configured to integrate generative AI models into the end-to-end pipeline of meal planning, ingredient aggregation, and inventory reconciliation.

Even when a generative AI model is used, it is often called in an ad-hoc manner, without a structured prompt generation process that embeds computed energy and nutrient constraints or current inventory status. This results in sub-optimal outputs that ignore actual pantry conditions, thereby requiring additional computation and user correction. The system cannot consistently generate meal plan data that is aligned with user goals and available ingredients, which increases the number of regeneration cycles and network calls to the AI model.

Third, conventional inventory management functions typically run independently from the meal planning logic. Ingredient lists are often processed with simple text matching, causing inconsistent normalization of ingredient names and units, and inefficient aggregation of required quantities. As a consequence, the system performs redundant comparisons and cannot efficiently identify shortage ingredient data, resulting in inaccurate or overly conservative shopping lists. This inefficient data processing degrades performance of database operations and increases memory usage.

Fourth, existing systems generally treat user feedback and emotional state information as optional metadata rather than as primary inputs to the computational pipeline. They do not systematically feed modification operations, evaluation data, and emotional state data back into the transformation that generates prompts for a generative AI model. Therefore, the system cannot adapt its internal computation flow to reduce unnecessary regeneration, cannot optimize prompt sentences for the model based on historical outcomes, and cannot exploit emotional state data to guide the selection of meals that improve user satisfaction or reduce cognitive load.

Accordingly, there is a need for a computer-implemented technique that improves the technical processing of user condition data, prompt generation, generative AI model invocation, ingredient aggregation, inventory comparison, and feedback-driven regeneration, in an integrated manner. Such a technique should reduce redundant computations, improve the efficiency and accuracy of the comparison between required ingredients and inventory data, and optimize the interaction with a generative AI model, thereby enhancing overall system performance and providing more relevant and technically coherent outputs to the user.

The specific processing by the specific processing unit 290 of the data processing device 12 in Example 2 is realized by the following means.

The present invention provides a server comprising a processor and a storage device, the processor being configured to receive, as input data via a user interface of a terminal device, user attribute data, nutritional condition data, energy amount condition data, preference condition data, prohibition condition data, goal condition data, and emotional state data, to compute, based on at least the nutritional condition data, the energy amount condition data, and the goal condition data, a total energy amount and nutrient intake amount for each day or each meal unit in a predetermined period, and to generate a structured prompt sentence that embeds the computed results together with the user attribute data, the preference condition data, the prohibition condition data, the goal condition data, and the emotional state data, the structured prompt sentence instructing a generative AI model to generate meal plan data; the processor further being configured to transmit the structured prompt sentence to the generative AI model via a communication interface, to obtain response data including period-based meal plan data and ingredient data corresponding to the meal plan data from the generative AI model, to parse and normalize the response data into structured data including meal data for each day or each meal unit and ingredient list data, to aggregate ingredient data in the ingredient list data to calculate required ingredient data in normalized units, to compare the required ingredient data with inventory data stored in the storage device to identify shortage ingredient data, to generate purchase candidate data or order data based on the shortage ingredient data, to convert the meal plan data, the required ingredient data, and the shortage ingredient data into user-interface data for presentation on the terminal device, to receive, via the terminal device, modification operations and evaluation data related to the meal plan data and the shortage ingredient data, to regenerate the structured prompt sentence based on the modification operations and the evaluation data and to cause the generative AI model to perform partial or entire regeneration of the meal plan data, and to update the inventory data in the storage device based on purchase result data transmitted from the terminal device and to use the updated inventory data in subsequent generation of the structured prompt sentence and in subsequent identification of the shortage ingredient data.

This enables integrated and efficient processing of heterogeneous user condition data, optimized prompt sentence generation for a generative AI model, accurate and resource-efficient aggregation and comparison of required ingredient data against inventory data, and adaptive regeneration of meal plan data based on user feedback and emotional states, thereby improving the technical performance and responsiveness of the computer-implemented meal planning and inventory management system.

The term “user attribute data” refers to data indicating characteristics of a user or a group of users, including, for example, age, sex, number of household members, and lifestyle patterns, which are used as parameters for generating meal plan data.

The term “nutritional condition data” refers to data indicating target amounts or ranges of nutrients to be taken by the user, such as protein, fat, carbohydrate, vitamins, minerals, and dietary fiber, over a specified period or per meal.

The term “energy amount condition data” refers to data indicating constraints on energy intake, such as target total calories per day, per meal, or per user, which are used to control the overall energy level of the generated meal plan data.

The term “preference condition data” refers to data indicating food preferences of the user, such as liked or disliked ingredients, preferred cuisines, cooking methods, or taste profiles, which are used to customize the meal plan data.

The term “prohibition condition data” refers to data indicating ingredients, dishes, or nutritional components that should be avoided by the user, for example due to allergies, religious restrictions, or medical limitations.

The term “goal condition data” refers to data indicating one or more target objectives related to diet or health, such as weight loss, weight gain, muscle increase, blood sugar control, or general health maintenance, and associated time frames or quantitative targets.

The term “emotional state data” refers to data indicating a psychological or emotional condition of the user at a given time or period, such as stress level, fatigue level, or mood, which is used to influence selection of meals and ingredients in the meal plan data.

The term “prompt sentence” refers to a text sequence or structured message generated by the processor and provided as an input to a generative AI model, the text sequence including instructions, constraints, and contextual information for causing the generative AI model to generate meal plan data and related ingredient data.

The term “structured prompt sentence” refers to a prompt sentence that includes explicit fields or segments encoding user attribute data, nutritional condition data, energy amount condition data, preference condition data, prohibition condition data, goal condition data, emotional state data, and computed constraint values, in a format suitable for consistent processing by a generative AI model.

The term “generative AI model” refers to a machine learning model configured to generate output data such as natural language text or structured data in response to an input prompt, the model being trained on large-scale data and capable of producing new meal plan data and ingredient data according to constraints described in a prompt sentence.

The term “meal plan data” refers to data representing one or more meals planned over a period, including at least information on dates or meal times and associated dishes or recipes, and optionally including estimated energy amounts and nutrient content for each meal.

The term “meal data” refers to data describing a single meal instance or a set of meals for a given time unit, including dish names, descriptions, and optionally nutritional information and preparation instructions.

The term “ingredient data” refers to data representing one or more ingredients associated with meals or dishes, including ingredient names, quantities, units, and optionally categories or storage conditions.

The term “ingredient list data” refers to data representing a collection of ingredient data aggregated from one or more meals or dishes in the meal plan data, typically expressed per day or per meal plan period.

The term “required ingredient data” refers to data representing total quantities of ingredients needed to execute the meal plan data over a predetermined period, the data being obtained by aggregating and normalizing the ingredient list data.

The term “inventory data” refers to data representing ingredients currently available to the user, including at least ingredient identifiers, available quantities, and units, stored in the storage device and updated based on purchase result data or consumption.

The term “shortage ingredient data” refers to data representing ingredients for which the required ingredient data exceeds corresponding quantities in the inventory data, and indicating deficit amounts that need to be procured.

The term “purchase candidate data” refers to data indicating a proposal of items to be purchased to resolve shortages, including at least identification of shortage ingredients and suggested purchase quantities, and optionally including store or delivery options.

The term “order data” refers to data formatted for placement of an order to an external service or commerce system, including item identifiers, quantities, and delivery or pickup information, derived from the shortage ingredient data.

The term “user-interface data” refers to data generated for presentation to the user via a terminal device, including layout information and content such as meal plan data, required ingredient data, and shortage ingredient data, in a format suitable for rendering on a display.

The term “terminal device” refers to an information processing device operated by the user, such as a smartphone, tablet, or personal computer, configured to transmit input data to the server and to present user-interface data received from the server.

The term “modification operations” refers to operations performed by the user via the terminal device to change at least part of the meal plan data or ingredient-related data, including operations such as replacing dishes, removing meals, or editing quantities of ingredients.

The term “evaluation data” refers to data representing a user's evaluation or feedback regarding generated meal plan data or ingredients, such as ratings, comments, or indications of satisfaction or dissatisfaction, acquired via the terminal device.

The term “purchase result data” refers to data indicating results of purchasing activities related to ingredients, including at least identifiers of purchased ingredients and purchased quantities, and optionally purchase times and sources, transmitted from the terminal device to the server.

The term “response data” refers to output data received from the generative AI model in response to a prompt sentence, the output data including at least meal plan data and corresponding ingredient data.

The term “storage device” refers to a memory or data storage component, such as a non-transitory computer-readable medium, that stores at least inventory data, meal plan data, and user-related condition data for processing by the processor.

The server executes the invention using a hardware configuration that includes at least one processor, a main memory, a non-transitory storage device, and a network interface.

The server may be implemented on a cloud computing platform or on an on-premise computing device. The server executes an operating system such as a general-purpose server operating system, and application software such as a web application framework or an application server. The server communicates with one or more terminal devices via a communication network such as the Internet or a local area network.

The terminal executes the client-side functions of the invention using a hardware configuration that includes a processor, a memory, a display, an input device such as a touch panel, and a communication module. The terminal may be implemented as a smartphone, a tablet, or a personal computer. The terminal executes a client application such as a native mobile application or a web browser, and displays a user interface for receiving user input and presenting meal plan information and ingredient information.

The user operates the terminal to provide user attribute data, nutritional condition data, energy amount condition data, preference condition data, prohibition condition data, goal condition data, and emotional state data. The user enters such information into input fields such as text fields, selection lists, and sliders displayed on the terminal. The user then triggers a transmission operation, and the terminal transmits the input data to the server as structured data, for example in a JavaScript Object Notation format over a secure communication protocol.

The server stores the received data as records in a relational data structure on the storage device. The server may use database management software such as a relational database system to manage tables representing user profiles, condition data, inventory data, and historical meal plans. The server normalizes and indexes these tables to enable efficient query execution. For example, the server stores user attribute data and goal condition data in separate normalized tables linked by user identifiers, which allows the server to quickly assemble all relevant data for a given user with a small number of indexed queries.

The server generates a prompt sentence for a generative AI model by transforming and combining the stored condition data into a structured text representation. The server uses a dedicated prompt generation module implemented in application software, which constructs the prompt sentence according to a pre-defined template that includes explicit labels and sections. The server embeds computed numerical values such as target total calories and nutrient ranges, derived from nutritional condition data and energy amount condition data, into the prompt sentence. In one embodiment, the server calculates, for each day in a planned period, an allowable total energy amount and a target range of protein, fat, and carbohydrate, and expresses these numbers in natural language in the prompt sentence. The server also embeds emotional state data as qualitative descriptors (for example, “high stress”, “low motivation”) and explicit instructions to bias meal selection toward simple preparation or comforting meals.

The server uses a generative AI model implemented as a neural network-based language model. The generative AI model may be executed on a separate model server or provided as an external service accessible via an application programming interface. The generative AI model may be defined as a multi-layer transformer network including an embedding layer, multiple self-attention layers, and a final output layer that produces token probabilities for text generation. The model is trained in advance on large corpora of text including recipe descriptions, nutritional guidance texts, and household cooking instructions. During training, the generative AI model minimizes a loss function such as cross-entropy loss between predicted token distributions and ground truth tokens, and updates model parameters by gradient-based optimization such as stochastic gradient descent or an adaptive variant.

The server uses a dedicated inference interface to call the generative AI model. The server transmits the prompt sentence and inference parameters such as maximum output length and sampling temperature to the model server. The generative AI model then processes the prompt sentence by converting tokens into vector representations using the embedding layer, applying self-attention mechanisms over multiple layers to model relationships between tokens representing constraints, conditions, and instructions, and predicting a sequence of output tokens that describe a meal plan. The generative AI model may produce output that explicitly includes daily meal entries, dish names, brief descriptions, and ingredients with approximate quantities.

The server receives the generated output from the generative AI model and parses the output using a parsing module. The server segments the output into structured elements corresponding to days, meal times, dishes, and ingredients. The server may use rule-based pattern recognition and token classification to detect ingredient lines, quantity expressions, and unit expressions. The server converts the parsed results into internal data structures such as arrays or dictionaries, where each entry includes normalized ingredient identifiers, numeric quantities, and units according to a standardized unit system. The server uses a reference table stored in the storage device to map various ingredient expressions to standardized ingredient identifiers. For example, the server may map “tomato”, “fresh tomatoes”, and “tomato (medium)” to a single internal ingredient identifier, and convert units such as “cup” or “piece” into grams using predefined conversion factors.

The server aggregates the normalized ingredient data to compute required ingredient data for an entire planning period. The server uses arithmetic operations to sum quantities per ingredient identifier over all meals in the meal plan. The server then compares the required ingredient data with inventory data stored in the storage device. The server executes database queries to retrieve current inventory quantities per ingredient identifier and performs vectorized or batched subtraction operations to compute shortages. When the required amount exceeds the inventory amount for an ingredient, the server records the difference as shortage ingredient data. The server may also apply threshold rules to treat very small deficits as negligible in order to avoid unnecessary purchases, thereby reducing the size of the shopping list and communication overhead for order placement.

The server generates purchase candidate data or order data based on the shortage ingredient data. The server may group shortage ingredients by category or supplier, and generate optimized purchase batches. This grouping and batching may reduce the number of external transactions when communicating with ordering systems or other external services, and thus reduce network load and latency. The server stores the shortage ingredient data and purchase candidate data in structured tables, allowing subsequent updates when the user confirms or modifies purchases.

The terminal receives user-interface data from the server and renders the meal plan and ingredient-related information on the display. The terminal may use a native graphical user interface framework or a web rendering engine. The terminal displays, for example, a calendar-like view showing daily meals and a separate list view showing shortage ingredient data together with required quantities. The user can scroll, select individual meals, and open detail screens showing ingredients and nutritional information.

The user may provide modification operations by selecting a meal and indicating replacement preferences, such as avoiding a particular ingredient or requesting simpler preparation. The user may also provide evaluation data by rating meals or marking them as “too complex” or “too expensive”. The terminal transmits these modification operations and evaluation data back to the server.

The server integrates the modification operations and evaluation data into a feedback processing module. The server updates preference condition data, prohibition condition data, and goal condition data based on the user's long-term feedback. The server adjusts the prompt generation logic to change how emphasis is placed on complexity reduction, ingredient diversity, or usage of existing inventory. For example, when the user frequently marks dishes as “too complex”, the server modifies the prompt sentence to add explicit constraints such as “prefer simple recipes with preparation time under 20 minutes” and “limit the number of distinct ingredients per meal”.

The server regenerates a prompt sentence when the user requests partial or entire regeneration of the meal plan. The server may restrict regeneration to specific days or meals, and may include, in the prompt sentence, the existing meal plan as context and explicit instructions to preserve certain dishes while replacing others. For example, the server may generate a prompt sentence such as:

“Regenerate only the dinner meals for days 3 to 5 of the following 7-day meal plan. Keep the total daily calories around 1,500 kcal per person, maintain balanced intake of protein, fat, and carbohydrates, and avoid shrimp and peanuts. The user prefers simpler recipes and has indicated that the previous dinners were too complex. Provide new dinner suggestions that use many of the same ingredients but reduce preparation complexity.”

The server transmits this revised prompt sentence to the generative AI model. The generative AI model generates new meal entries for the specified portion, and the server merges the new meal entries into the existing plan while maintaining index consistency for days and meals.

Because the server performs partial regeneration and reuses previously normalized and aggregated data where possible, the system reduces computational load and avoids full reprocessing of all days, which improves response time and reduces the number of calls to the generative AI model.

The server updates inventory data based on purchase result data provided by the user through the terminal. For example, when the user marks specific ingredients as purchased, the terminal transmits ingredient identifiers and purchased quantities to the server. The server then updates the inventory data tables using atomic add operations to ensure data consistency even under concurrent access. The server may also store purchase history records in a separate table, including timestamps and quantities, to allow future analysis of consumption patterns.

The server improves computer technology by using structured prompt sentences and integrated condition data to reduce redundant computation and network communication.

Because the server embeds calculated constraints and up-to-date inventory status directly in the prompt sentence, the generative AI model can generate meal plan data that is already aligned with nutritional and inventory constraints. As a result, the server requires fewer post-processing corrections and fewer regeneration cycles, which reduces processor load and network bandwidth usage. The use of normalized ingredient identifiers and standardized units reduces ambiguity in aggregation and comparison, leading to more accurate inventory reconciliation and reduced error propagation.

The server cannot be regarded as performing simple automation of a human mental process.

A human planner would not naturally represent inventory, nutrient targets, and emotional state as integrated vectorized data structures and would not interact with a high-dimensional neural network using structured prompt construction and iterative feedback loops optimized for computational efficiency. The server, by contrast, reorganizes the data into specialized relational structures, transforms such data into structured prompt sentences designed for a specific neural architecture, and orchestrates partial regeneration using machine-level indexing and aggregation techniques.

The generative AI model differs from a conventional rule-based engine by using learned sequence representations and attention mechanisms to adapt to complex constraint combinations without exponential growth of explicitly coded rules. The server further customizes the interaction with the generative AI model by adjusting inference parameters and prompt structure based on error patterns or evaluation data. For instance, the server can lower the sampling temperature or restrict token choices to a domain-specific vocabulary for ingredients to reduce variability and improve relevance, which leads to higher precision of generated ingredient data and less parsing overhead.

The server can implement variant embodiments. In one embodiment, the server executes the generative AI model locally on a dedicated accelerator device such as a graphics processing unit or a specialized neural network processor. In this case, the server stores the model parameters in local memory and performs forward propagation operations directly. The server can then adjust computational precision (for example, using reduced precision arithmetic) and batch size for inference to optimize latency and throughput. In another embodiment, the server uses a smaller distilled neural model for on-device inference when low latency is required, and uses a larger model only when a high-quality meal plan is requested, thereby dynamically balancing resource usage and output quality.

The terminal can also implement variants for user interaction. In one embodiment, the terminal provides real-time updates as the user modifies condition data, and the server uses lightweight heuristic computations to give immediate visual feedback before full regeneration by the generative AI model. In another embodiment, the terminal caches the latest meal plan and ingredient data locally, so that the user can view and interact with the information offline, and the terminal resynchronizes with the server when connectivity is restored. This reduces network usage and improves usability in low-connectivity environments.

The user can use the system in different application scenarios. In a first example, the user sets a goal of losing 2 kilograms in one month and specifies a family of two adults. The user selects preferred cuisines and indicates an allergy to peanuts and shrimp. The server computes daily energy targets and constructs a prompt sentence such as:

“Create a 7-day low-calorie meal plan for a family of 2 adults. The goal is weight loss of 2 kg in 1 month. Limit daily calories to about 1,500 kcal per person, ensure balanced intake of protein, fiber, vitamins, and minerals, and avoid shrimp and peanuts. Provide breakfast, lunch, and dinner for each day with dish names, short descriptions, and estimated calories per meal.”

The generative AI model returns meal plan data, and the server performs normalization, aggregation, and inventory comparison to generate shortage ingredient data. The terminal displays the meal plan and the corresponding shopping list, and the user can then proceed to purchase missing ingredients.

In a second example, the user indicates a desire to use mainly existing ingredients such as chicken breast, tofu, carrots, onions, spinach, brown rice, and canned tomatoes. The server generates a prompt sentence such as:

“Based on the following available ingredients: chicken breast, tofu, carrots, onions, spinach, brown rice, and canned tomatoes, create a 5-day dinner plan for 1 adult who wants to lose weight. Use mainly these ingredients, keep daily calories around 1,400 kcal, and ensure balanced nutrition. Minimize the number of new ingredients that need to be purchased. Provide dish names, brief recipes, and an aggregated ingredient list.”

The server embeds the current inventory levels for these ingredients and any additional constraints into the prompt sentence. The generative AI model generates meals that focus on existing ingredients, and the server calculates a smaller shortage ingredient list, thereby reducing food waste and shopping burden. The technical effect in this case includes reduced memory and processing required for inventory updates and order generation because the aggregated shortage list is shorter and more focused.

In a third example, the user indicates high stress and low available time for cooking. The user sets emotional state data and selects a goal of maintaining weight. The server generates a prompt sentence that includes such information, for example:

“The user is under high stress and has limited time for cooking. Create a 7-day dinner plan for 1 adult that maintains current weight with about 1,800 kcal per day, uses simple recipes with preparation time under 20 minutes, and provides comforting and easy-to-digest meals. Avoid spicy foods and shellfish.”

The generative AI model generates a meal plan that emphasizes simple recipes. The server parses and aggregates the data and displays the results on the terminal. By explicitly encoding emotional state and preparation time constraints in the prompt and by normalizing and aggregating the resulting ingredient data, the system achieves a more technically efficient and user-adapted outcome than a simple rules-based or template-based system. The causal relationship between the structured prompt generation, neural model inference, and inventory-aware aggregation leads directly to improved response time, improved accuracy of ingredient matching, and reduced number of user corrections, demonstrating a concrete improvement in the functioning of the computer-based meal planning and inventory management system.

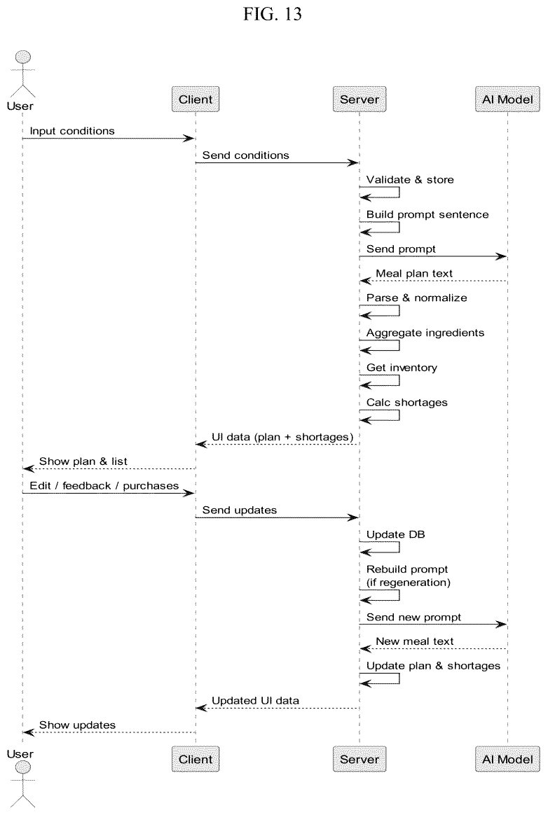

The following describes the processing flow using FIG. 13.

### Step 1:

The user operates the terminal to input condition data. The user opens an application screen on the terminal and enters user attribute data, nutritional condition data, energy amount condition data, preference condition data, prohibition condition data, goal condition data, and emotional state data into form fields such as text boxes, selection lists, and sliders. The user then activates a send control (for example, a “Submit” button). As input, the terminal receives raw user keystrokes and touch events, and the application converts these events into structured key-value pairs. As output, the terminal generates structured condition data, for example a JSON object, and transmits it over a secure channel (HTTPS) to the server.

### Step 2:

The server receives and validates the condition data. As input, the server obtains the structured condition data in the body of an HTTP request. The server parses the JSON payload into internal data structures (for example, objects and arrays) and performs validation checks, such as verifying that numeric fields (calories, nutrient targets) are within plausible ranges and that required fields (goal, household size) are present. The server performs data type checks and range checks and, if needed, normalizes categorical values (for example, mapping “lose weight” and “weight loss” to a single internal code). As output, the server produces a validated and normalized condition data set suitable for storage and later computation.

### Step 3:

The server stores the condition data in a database. As input, the server receives the validated condition data set from the previous processing step. The server maps each field to columns in relational tables, such as a user profile table, a nutrition constraints table, and a goals table.

The server then executes database insert or update commands to write these values into a relational database management system. During this process, the server assigns or references a user identifier and foreign keys to maintain relational integrity. As output, the server produces persistent records in the storage device and returns internal identifiers that will be used in subsequent queries.

### Step 4:

The server computes numerical constraints for energy and nutrients. As input, the server retrieves the stored nutritional condition data, energy amount condition data, and goal condition data from the database using indexed queries keyed by the user identifier. The server performs arithmetic operations to calculate, for each day or each meal unit in a planning period, a target total energy amount and target ranges for macronutrients and optionally key micronutrients. For example, the server may divide a daily calorie target among breakfast, lunch, and dinner according to predefined ratios, and derive grams of protein and carbohydrates using nutritional formulas. As output, the server generates a set of computed constraint values, such as per-meal target calories and nutrient ranges, represented as structured numeric data.

### Step 5:

The server constructs a structured prompt sentence for a generative AI model. As input, the server uses the normalized condition data and the computed constraint values. The server applies a template-based generation algorithm that concatenates fixed phrases with inserted values, and arranges information into labeled sections (for example, “User profile”, “Goals”, “Constraints”, “Inventory context”). The server converts numeric constraints into text, for example “about 1,500 kcal per person per day” or “at least 80 grams of protein per day”. The server also encodes emotional state data as descriptive phrases, such as “high stress” or “low available time for cooking”. As output, the server produces a prompt sentence in natural language that explicitly instructs the generative AI model to generate meal plan data under the specified constraints. Example prompt sentences include:

“Create a 7-day low-calorie meal plan for a family of 2 adults. The goal is weight loss of 2 kg in 1 month. Limit daily calories to about 1,500 kcal per person, ensure balanced intake of protein, fiber, vitamins, and minerals, and avoid shrimp and peanuts. Provide breakfast, lunch, and dinner for each day with dish names, short descriptions, and estimated calories per meal.”

and

“Based on the following available ingredients: chicken breast, tofu, carrots, onions, spinach, brown rice, and canned tomatoes, create a 5-day dinner plan for 1 adult who wants to lose weight. Use mainly these ingredients, keep daily calories around 1,400 kcal, and ensure balanced nutrition. Minimize the number of new ingredients that need to be purchased. Provide dish names, brief recipes, and an aggregated ingredient list.”

### Step 6:

The server transmits the prompt sentence to the generative AI model and requests inference.

As input, the server uses the prompt sentence and a set of inference parameters such as maximum token length, sampling temperature, and top-k or top-p sampling thresholds. The server constructs an API request payload with these elements and sends it via a network interface to a model server hosting the generative AI model. The server includes authentication information and model selection parameters. As output, the server produces a network request and initiates a remote computation, then waits for the generative AI model to return response data.

### Step 7:

The generative AI model generates meal plan data in response to the prompt sentence. As input, the model server receives the prompt sentence and configuration parameters. The model tokenizes the prompt sentence, converts tokens into vector embeddings, passes them through multiple transformer layers with self-attention operations, and computes probability distributions over output tokens at each decoding step. The model performs iterative decoding, selecting tokens according to the configured sampling strategy, thereby constructing an output text sequence that describes a meal plan and associated ingredients.

The model may structure the output as day-by-day entries, each containing meals, dish names, brief descriptions, and ingredient lines. As output, the generative AI model returns the generated text sequence to the server as response data.

### Step 8:

The server parses and normalizes the response data from the generative AI model. As input, the server receives the generated text sequence within the AI response. The server applies a parsing module that uses pattern matching, tokenization, and possibly simple syntax rules to segment the text into units representing days, meal times, dish entries, and ingredient entries.

The server identifies ingredient names, quantities, and units by locating numeric tokens followed by unit tokens and ingredient tokens. The server then uses a reference table, stored in the database, to map each ingredient expression to a standardized ingredient identifier and to convert various units to standard units (for example, grams). As output, the server produces structured meal plan data and ingredient list data in internal data structures, where each element has normalized identifiers, numeric quantities, and normalized units.

### Step 9:

The server aggregates ingredient data into required ingredient data. As input, the server uses the normalized ingredient list data generated in the previous step. The server groups entries by ingredient identifier and sums the quantities for each identifier over the entire planning period or over a selected subset (for example, only dinners). The server performs arithmetic addition operations on numeric fields and may apply rounding rules to express final values in practical units. The server may also calculate per-day averages or per-meal averages if required. As output, the server produces required ingredient data that indicates the total amount of each ingredient needed to execute the meal plan.

### Step 10:

The server retrieves and normalizes inventory data. As input, the server accesses the storage device and queries the inventory tables using the user identifier. The server obtains current quantities and units for each ingredient in the user's inventory. The server normalizes inventory units to the same standard unit system used for required ingredient data, using conversion factors stored in a unit conversion table. The server also maps any nonstandard ingredient labels to the standardized ingredient identifiers. As output, the server produces a normalized inventory data set aligned with the required ingredient data by ingredient identifier and unit.

### Step 11:

The server compares required ingredient data to inventory data to determine shortage ingredient data. As input, the server uses both the aggregated required ingredient data and the normalized inventory data. The server joins these data sets by ingredient identifier and computes, for each ingredient, the difference between the required quantity and the inventory quantity using subtraction operations. If the difference is greater than zero (or a configurable threshold), the server records this difference as a shortage amount. The server may filter out ingredients with zero or negligible shortage and may rank shortages by amount or category.

As output, the server produces shortage ingredient data identifying which ingredients need to be procured and in what quantities.

### Step 12:

The server generates purchase candidate data or order data from the shortage ingredient data.

As input, the server takes the shortage ingredient data produced in the comparison step. The server groups shortage ingredients according to supplier, category, or storage requirements, based on classification information stored in a reference table. The server calculates suggested purchase quantities, potentially adding safety margins or rounding to package sizes. The server then formats these grouped and adjusted shortages into purchase candidate data for user review or into order data suitable for submission to an external ordering system.

As output, the server produces structured purchase candidate data and optionally machine-readable order data.

### Step 13:

The server constructs user-interface data that combines meal plan data and ingredient-related data. As input, the server uses the structured meal plan data, required ingredient data, shortage ingredient data, and purchase candidate data. The server generates layout-oriented data structures describing how to present daily meals, dish details, and corresponding ingredient information on the terminal. For example, the server creates a hierarchical representation with days at the top level, meals as children, and ingredients as subentries. The server also prepares a separate list view structure for shortage ingredients, including fields for quantities, units, and purchase options. As output, the server produces user-interface data encoded as JSON or another structured format, ready to be rendered by the terminal.

### Step 14:

The terminal receives and renders the user-interface data. As input, the terminal obtains the user-interface data in the body of an HTTP response from the server. The terminal parses the structured data into in-memory objects using its runtime environment. The terminal then calls graphical user interface components to render lists, tables, and detail views corresponding to the meal plan and shopping list. The terminal maps each data field (for example, dish name, calories, ingredient quantity) to a visual element, sets labels and values, and attaches interactive controls such as buttons and checkboxes. As output, the terminal displays updated screens on the display so that the user can view meals, inspect nutritional information, and review shortage ingredient data.

### Step 15:

The user reviews and modifies the meal plan and shopping list. As input, the user observes the rendered information on the terminal and performs interaction operations such as tapping edit icons, selecting alternative dishes, removing meals, or changing quantities of ingredients.

The user may also rate specific dishes or mark ingredients as “already purchased” or “not needed”. The terminal captures these actions as modification operations and evaluation data, translating touch events into updated data fields and update commands. As output, the user indirectly produces updated meal preferences, updated shortage status, and feedback markers, which the terminal then prepares as structured update data.

### Step 16:

The terminal transmits modification operations, evaluation data, and purchase results to the server. As input, the terminal uses the updated fields representing user edits, ratings, and purchase confirmations. The terminal packages these updates into one or more update messages that include identifiers for the user, the meal plan entries, and the ingredients. The terminal sends these messages to the server using HTTP methods such as POST or PUT. As output, the terminal delivers structured update data, including modification operations, evaluation data, and purchase result data, to the server for processing.

### Step 17:

The server updates condition data, meal plan data, and inventory data based on the received updates. As input, the server receives the structured update data from the terminal. The server interprets modification operations to update corresponding records in the meal plan tables, adjusts preference condition data or prohibition condition data based on repeated patterns in evaluation data, and modifies inventory data by adding purchased quantities or marking items as consumed. The server executes database update statements to ensure that changes are persisted. For example, when the user marks an ingredient as purchased, the server increments the inventory quantity for that ingredient. As output, the server produces updated database records that reflect the user's latest state and preferences.

### Step 18:

The server regenerates a prompt sentence and partially regenerates the meal plan when requested. As input, the server uses the updated condition data and the current meal plan data, including indications of which days or meals the user wants to change. The server constructs a new prompt sentence that includes explicit instructions for partial regeneration, such as specifying days 3 to 5 only, maintaining calorie constraints, and avoiding disliked ingredients identified from evaluation data. The server may include the unchanged portions of the plan as context and add directions that new meals should reuse existing ingredients to respect inventory constraints. The server then repeats the interaction with the generative AI model as in the earlier steps: sending the revised prompt sentence, receiving new text output, parsing and normalizing the new portion, and merging it into the existing meal plan. As output, the server produces an updated meal plan with replaced segments, and the associated ingredient data is recalculated and re-compared with inventory data, resulting in updated shortage ingredient data.

### Step 19:

The server and terminal cooperate to present updated results and reduce computational and communication load in subsequent cycles. As input, the server takes the updated meal plan, ingredient data, and inventory data after partial regeneration and inventory updates. The server can cache intermediate computations such as normalized ingredient mappings and aggregated quantities for unchanged days, so that only the modified portions are recomputed.

The terminal receives only the changed user-interface data elements and re-renders only the affected screens or components. As output, the system provides an updated user view with minimal delay while avoiding full recomputation and full-screen redraws, thereby improving response time, reducing the number of calls to the generative AI model, and lowering data transfer volume between the server, the model server, and the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional meal recommendation and grocery ordering systems generally rely on a sequence of loosely coupled modules: a static rules engine or simple recommender for suggesting meals, a separate inventory checker, and a separate ordering interface that requires explicit user input. In such architectures, user-specific parameters such as household composition, nutritional requirements, energy (calorie) constraints, food preferences, dietary restrictions, and emotional state are only partially or inconsistently reflected in the final ordered items. As a result, these systems often generate meal plans that violate nutritional or allergy constraints, fail to adapt to a user's changing emotions, or require repeated manual corrections. This leads to increased user interaction overhead, inefficient use of network and computing resources due to multiple trial-and-error service calls, and redundant data processing on both the client and server sides.

Furthermore, conventional use of large-scale generative AI models in this field is typically limited to isolated text generation based on a simple prompt. Existing systems do not automatically construct a context-rich prompt sentence that encodes machine-readable constraint conditions (for example, nutrient and energy limits), evaluation conditions (for example, comfort level, preference priorities), and inventory state in a structured and repeatable way. They also do not automatically verify the generated output against nutritional constraints and allergy restrictions, normalize ingredient names, aggregate quantities across a planning period, and drive downstream ordering to external delivery services in a closed loop. Consequently, the generative AI model output is under-constrained, which forces additional manual review or post-processing and diminishes the technical efficiency of the overall computation.

In addition, in conventional systems, emotional state information of the user when used at all is handled as an ancillary UI feature rather than as a first-class parameter integrated into the core computational pipeline. There is no standardized mechanism by which the server acquires emotional state from multimodal data (image, audio, text), maps that state to parameterized constraints on food categories (for example, stress-relief, comforting, celebratory), and injects those constraints into the prompt sentence supplied to the generative AI model. This lack of integration prevents systematic optimization of user-specific meal plans in response to temporal changes in user emotions, resulting in sub-optimal personalization and repeated, inefficient reconfiguration of the system.

Moreover, typical systems do not exploit user feedback (for example, acceptance or rejection of proposed dishes) in a way that directly updates an internal representation of preference and restriction conditions and regenerates prompt sentences accordingly. Instead, feedback is often stored only as coarse historical logs, and subsequent recommendations are generated using static or periodically recalculated profiles, which leads to latency in adaptation, increased storage overhead, and unnecessary repeated computations.

Accordingly, there is a need for an improved computer-implemented system that: (i) systematically acquires heterogeneous user-related information including emotional state; (ii) computes formal constraint and evaluation conditions for meal planning; (iii) automatically generates rich prompt sentences for a generative AI model that encode those conditions; (iv) parses the model's textual output into structured, machine-processable ingredient demand information; (v) compares that demand against inventory information to identify shortages; (vi) automatically generates and transmits order requests to external delivery services; and (vii) updates preference and restriction conditions based on explicit user interactions, thereby closing the loop. Such a system should reduce redundant computations, network traffic, and user operations, while increasing the consistency and technical reliability of end-to-end meal planning and ordering.

The specific processing by the specific processing unit 290 of the data processing device 12 in Application Example 2 is realized by the following means.

The present invention provides a server comprising a processor configured to acquire, from a client terminal, household composition information, nutritional condition information, energy condition information, preference condition information, restriction condition information, and emotional state information of a user, to store the acquired information in an associated storage resource, and to obtain nutrient component information from a nutrition database; to determine, by execution of programmed instructions, constraint conditions and evaluation conditions for a meal plan that satisfies desired nutritional conditions and energy conditions based on the stored information and the nutrient component information; to automatically generate a prompt sentence that includes the constraint conditions, the evaluation conditions, the preference condition information, the restriction condition information, and the emotional state information, to transmit the prompt sentence as an input to a generative AI model via a communication interface, and to receive, from the generative AI model, response information including meal plan information; to perform character-string analysis processing on the response information in order to extract dish information and ingredient information, and to perform name-normalization processing and quantity-aggregation processing on the ingredient information so as to generate ingredient demand information representing required ingredients and corresponding quantities; to execute database matching processing that compares the ingredient demand information with ingredient inventory information associated with the user and stored in the storage resource, and to identify shortage ingredient information representing ingredients that are required but not sufficiently available; to acquire, based on the shortage ingredient information, item candidate information from an external item-information providing service via the communication interface, to generate order candidate information by associating candidate items with the shortage ingredient information, to automatically generate order request data for an external delivery service based on the order candidate information, to transmit the order request data to the external delivery service via the communication interface, and to receive order confirmation information from the external delivery service; and to transmit, to the client terminal, the meal plan information, the shortage ingredient information, and the order confirmation information, and to cause, via a user interface executed on the client terminal, the meal plan information to be displayed in a format classified by date and meal category and to cause orderable information including delivery status information derived from the order confirmation information to be presented to the user, and further to acquire, from the client terminal, a selection operation or a rejection operation with respect to the response information, to update the preference condition information and the restriction condition information based on contents of the selection operation or the rejection operation, and to regenerate a prompt sentence reflecting the updated condition information and to re-input the regenerated prompt sentence to the generative AI model so as to re-propose meal plan information. This enables an integrated and technically improved computational pipeline in which heterogeneous user and inventory data are transformed into formal constraint conditions, encoded into a structured prompt sentence for the generative AI model, verified and normalized into machine-readable ingredient demand information, and automatically linked to inventory comparison and external ordering, while continuously adapting preference and restriction conditions based on explicit user feedback and emotional state, thereby reducing redundant computations, network transactions, and user interactions relative to conventional systems and improving the efficiency, reliability, and personalization quality of computer-implemented meal planning and ordering.

The term “household composition information” refers to information indicating a configuration of persons sharing meals, including at least a number of persons and optionally age group, relationship, or dietary category of each person.

The term “nutritional condition information” refers to information indicating desired intake conditions of nutrients, such as target amounts or ranges of proteins, lipids, carbohydrates, vitamins, minerals, or other nutritional components over a specified period.

The term “energy condition information” refers to information indicating desired intake conditions of energy, including at least a target total caloric value or caloric range for a meal, a day, or a planning period.

The term “preference condition information” refers to information indicating tendencies of liking or disliking of a user with respect to food items, dishes, cooking methods, flavors, or other meal characteristics.

The term “restriction condition information” refers to information indicating limitations on food intake of a user, including at least allergy-related limitations, medical dietary restrictions, religious or ethical prohibitions, or other exclusion conditions.

The term “emotional state information” refers to information indicating a psychological state of a user at a particular time, such as stress, sadness, joy, excitement, or calmness, obtained by explicit input or by analysis of sensory data.

The term “nutrition database” refers to a structured data store that associates food items or ingredients with nutrient component information, including at least calories and one or more nutritional components.

The term “nutrient component information” refers to information indicating quantitative nutritional properties of a food item or ingredient, such as caloric value and amounts of macronutrients and micronutrients per unit quantity.

The term “constraint conditions” refers to formalized conditions used by the processor to limit candidate meal plans, including at least nutritional constraints, energy constraints, and restriction-based exclusions.

The term “evaluation conditions” refers to formalized conditions used by the processor to assess and rank candidate meal plans, including at least weighting factors for preferences, emotional suitability, variety, or cost.

The term “prompt sentence” refers to a text sequence generated by the processor that encodes constraint conditions, evaluation conditions, and user-related information, and that is supplied as input to a generative AI model to obtain response information.

The term “generative AI model” refers to an information processing model trained on data to generate text or other content in response to a given input, and that outputs meal plan information when provided with a prompt sentence.

The term “response information” refers to information output by the generative AI model in response to the prompt sentence, including at least textual descriptions of meal plans and dish-related information.

The term “meal plan information” refers to information indicating a structured plan of meals for one or more days, including at least dish identification for each meal time and optionally associated ingredient indications.

The term “dish information” refers to information indicating an individual prepared food item or recipe, including at least a dish name and optionally a description of the dish.

The term “ingredient information” refers to information indicating one or more food components used for preparing a dish, including at least an ingredient name and optionally an associated amount or unit.

The term “name-normalization processing” refers to processing for converting different textual expressions referring to a same ingredient into a unified canonical expression.

The term “quantity-aggregation processing” refers to processing for summing or otherwise aggregating required quantities of ingredients across multiple dishes or days to obtain a total required quantity per ingredient.

The term “ingredient demand information” refers to information generated by the processor that represents normalized ingredient identifiers and corresponding aggregated required quantities for a meal plan.

The term “ingredient inventory information” refers to information representing ingredients currently available to a user, including at least identifiers of ingredients and their available quantities, and optionally expiration information.

The term “shortage ingredient information” refers to information indicating ingredients for which a required quantity derived from ingredient demand information exceeds an available quantity derived from ingredient inventory information.

The term “database matching processing” refers to processing by which the processor compares structured data sets, including at least comparing ingredient demand information with ingredient inventory information to determine shortages.

The term “external item-information providing service” refers to an external system that provides, via a communication interface, information about purchasable items, including at least product identifiers, descriptions, and package sizes.

The term “item candidate information” refers to information received from the external item-information providing service indicating a plurality of purchasable items that can potentially satisfy a required ingredient.

The term “order candidate information” refers to information generated by associating shortage ingredient information with one or more item candidates, and including at least selected products and quantities to be ordered.

The term “order request data” refers to structured data including at least product identifiers, quantities, and delivery destination information, generated by the processor and transmitted to an external delivery service to request a purchase and delivery.

The term “order confirmation information” refers to information received from the external delivery service indicating a result of an order request, including at least an order identifier, acceptance status, and expected delivery time.

The term “external delivery service” refers to an external system that receives order request data, arranges procurement and transportation of items, and returns order confirmation information.

The term “client terminal” refers to an information processing apparatus operated by a user, such as a mobile apparatus or a computing apparatus, that communicates with the server to send user-related information and to receive and display output information.

The term “user interface” refers to a presentation and input environment executed on the client terminal that allows the user to view meal plan information, shortage ingredient information, order-related information, and to perform selection or rejection operations.

The term “selection operation” refers to an explicit user input indicating acceptance or positive selection of at least part of the meal plan information or proposed dishes.

The term “rejection operation” refers to an explicit user input indicating non-acceptance or negative selection of at least part of the meal plan information or proposed dishes.

The term “meal planning period information” refers to information indicating a temporal range, including at least a number of days or specific dates, over which a meal plan is to be generated.

The term “image information” refers to electronic data representing a visual capture of a user or environment, obtained for example from an imaging sensor.

The term “audio information” refers to electronic data representing sound including at least voice of a user, obtained for example from a sound sensor.

The term “text information” refers to character sequence data representing linguistic content input by a user or generated by transcription.

The term “emotion analysis processing” refers to processing that analyzes at least one of image information, audio information, and text information to estimate an emotional state of a user.

The term “stress-relief food materials” refers to food items or ingredients that are pre-defined in the system as suitable for reducing stress or providing a calming effect.

The term “comforting food materials” refers to food items or ingredients that are pre-defined in the system as suitable for providing psychological comfort to a user.

The term “celebratory food materials” refers to food items or ingredients that are pre-defined in the system as suitable for use in celebration or special occasions.

The term “orderable information” refers to information presented to the user indicating that one or more items or menus can be ordered, including at least associated delivery status information.

The term “delivery status information” refers to information indicating a current state of an order handled by an external delivery service, including at least an expected delivery time and, optionally, intermediate status updates.

In one embodiment, a system includes a server, at least one client terminal, at least one storage device, and at least one communication network. The server includes at least one processor and at least one memory storing program instructions that, when executed by the processor, cause the server to perform the functions described below. The terminal includes an input/output interface, a display device, and at least one sensor such as a camera or a microphone.

The server executes an application implemented, for example, using a general-purpose programming language such as Python running on an operating system such as a server-grade operating system. The server accesses a relational database management system such as a relational database engine (for example, MySQL-type engine) that stores user profiles, ingredient inventory records, nutrition tables, and logs. The server further communicates, via a network stack (for example, TCP/IP over HTTPS), with one or more external services including a generative AI model endpoint, an external item-information providing service, and an external delivery service.

The terminal executes a native or web-based application, for example, a mobile application or browser-based application that provides graphical user interface screens for user interaction.

The terminal acquires user inputs such as textual information, menu selections, and emotional self-reports via the display and input devices. The terminal also acquires sensor data such as image frames from a camera or audio signals from a microphone via native device drivers.

The terminal may additionally call an external emotion analysis service (for example, an API providing emotion classification for images, audio, or text) and receive as output an estimated emotional state.

The user operates the terminal to register and update household composition information, nutritional condition information, energy condition information, preference condition information, restriction condition information, inventory information, and emotional state information. The terminal converts these inputs into structured records with predefined fields, such as key-value pairs, and transmits them to the server over the network as request payloads conforming to an application-specific protocol such as REST over HTTPS.

The server stores the received user-related information in one or more database tables. For example, the server stores household composition information, preferences, and restrictions in a user profile table; stores per-item inventory in an inventory table including fields for item identifier, quantity, unit, and expiration date; and stores nutritional condition information and energy condition information in a constraint table. The server also stores emotional state information in an emotion history table whose records include a timestamp, a user identifier, and an emotion label, optionally with a confidence value.

The server loads nutrition tables into memory from the database or from structured files such as CSV files. The server organizes nutritional data in indexed structures (for example, hash maps keyed by ingredient identifier) to enable low-latency lookup of nutrient component information such as per-unit calories, macronutrient content, and micronutrient content. By pre-loading and indexing these data, the server reduces repeated disk I/O and improves computation speed when evaluating candidate meal plans.

The server computes constraint conditions and evaluation conditions for meal planning by executing numerical operations on the stored data. The server combines user-specified calorie targets with household composition information to determine per-person and per-meal energy budgets. The server computes daily or period-wide target ranges for nutrients such as protein, fiber, and vitamins by applying formulas or lookup rules to the nutritional condition information and standard recommendation tables. The server represents these constraint conditions in a machine-readable structure that includes, for each nutrient or energy parameter, a lower bound, an upper bound, and an optional priority weight.

The server computes evaluation conditions that reflect preference condition information, restriction condition information, and emotional state information. The server, for example, encodes preference strengths for ingredient categories (such as “likes chicken,” “likes broccoli,” “dislikes spicy food”) and emotional suitability weights (such as high weight for “comfort foods” under a stressed state). The server represents these evaluation conditions as scoring parameters that are later used to assess or guide the generation of meal plans.

The server generates a prompt sentence by transforming the constraint conditions and evaluation conditions into a natural-language specification. The server uses a templating mechanism in which the processor fills textual templates with parameter values, such as numerical ranges and ingredient names. The prompt sentence therefore includes explicit constraints for daily calorie limits, required nutrients, prohibited ingredients, preferred flavors, and contextual emotional information. An example prompt sentence is:

### “User Profile:

Family structure: 2 adults and 2 children
Goal: lose 2 kg in 1 month
Daily calorie limit: 1800 kcal
Required nutrients: balanced protein and vitamin C
Preferences: likes chicken and broccoli, dislikes spicy food
Allergies: nuts
Current emotion: stressed

### Task:

You are a professional dietitian.

Please propose a detailed 3-day meal plan with breakfast, lunch, and dinner.

The plan must:
Stay within 1800 kcal per day,
Include chicken and broccoli several times,
Strictly avoid all nuts and spicy dishes,
Provide comforting, stress-relief style meals suitable for a stressed user.

For each meal, list the dish name and main ingredients.”

The server transmits the prompt sentence to a generative AI model deployed as an external inference service. In one embodiment, the generative AI model is a neural network based on a transformer architecture with multiple self-attention layers, feedforward layers, and layer normalizations. The model accepts as input a sequence of tokens obtained from the prompt sentence by a tokenizer, and processes the token sequence using attention mechanisms that compute weighted combinations of token embeddings based on learned weight matrices. The model generates output tokens autoregressively, where each new token is sampled or selected based on a probability distribution obtained from a softmax function applied to a linear transformation of the model's internal representation.

The server, during development and training of the generative AI model, uses training examples that map prompt sentences describing constraints and user states to desirable meal plan texts. The server (or a training subsystem) minimizes a loss function such as cross-entropy between the model's predicted token distributions and ground-truth tokens. The server updates model weights via gradient-based optimization such as stochastic gradient descent with momentum or adaptive gradient methods, based on backpropagation through the transformer layers. The server may additionally apply regularization techniques such as dropout and data augmentation methods such as paraphrasing of prompt sentences and variation of dish descriptions to improve robustness.

The server, at inference time, sends the prompt sentence to the generative AI model via a network request. The server receives as output a text sequence that includes a multi-day meal plan and lists of dishes and ingredients. The server performs character-string analysis on this response text. The server parses the text based on expected patterns, such as section headers “Day 1,” “Breakfast,” “Lunch,” and lists labeled “Ingredients:”. The server uses deterministic parsing rules, optionally complemented by finite-state machines or regular expressions, to segment the text into dish entries and to extract ingredient entries from bullet lists.

The server performs name-normalization processing by mapping each extracted ingredient description to a canonical ingredient identifier. The server uses techniques such as case normalization, removal of stop-words, stemming, and matching against a controlled vocabulary stored in the database. The server may apply approximate string matching algorithms such as edit-distance or token-based similarity to handle variations in naming. By enforcing canonical ingredient identifiers, the server ensures consistent indexing into the nutrition database and the inventory database, thereby reducing ambiguity and mismatches.

The server performs quantity-aggregation processing across the entire meal planning period.

The server interprets textual quantity expressions (for example, “1 cup,” “100 g,” “2 pieces”) by converting them to standardized units based on a conversion table stored in the database.

The server aggregates the required quantity for each canonical ingredient by summing the standardized quantities over all dishes and days. The server outputs ingredient demand information that associates each canonical ingredient identifier with a total required quantity and unit.

The server compares the ingredient demand information with ingredient inventory information stored in the database. The server loads current inventory records into memory and maps the inventory units to the same standardized units used in the demand information.

The server subtracts available quantities from required quantities to determine, for each ingredient, whether there is a surplus or shortage. The server then generates shortage ingredient information for ingredients with positive deficit values. Because the server performs these comparisons using structured, normalized identifiers and units, the server can compute shortages accurately without error-prone manual calculations.

The server optionally evaluates whether the generated meal plan satisfies nutritional and energy constraints by recomputing total caloric and nutrient values based on the normalized ingredient demand information and the nutrition database. This verification step allows the server to detect and correct cases where the generative AI model produced plans that do not fully satisfy the numerical constraints. The server, upon detecting a violation, may generate a revised prompt sentence that explicitly instructs the generative AI model to correct the deficiencies, thereby creating a closed feedback loop that improves adherence to constraints.

The server interacts with an external item-information providing service to translate shortage ingredient information into orderable items. The server sends the canonical ingredient identifiers and quantities to the external service, which returns item candidate information such as product identifiers, package sizes, and prices. The server selects candidate items according to selection rules, such as minimizing cost, minimizing the number of distinct products, or preferring certain brands or labeling properties. The server forms order candidate information by pairing each shortage ingredient with one or more selected products and computing the number of packages needed to satisfy the required quantity.

The server generates order request data for an external delivery service. The server composes structured order data that includes user delivery address, selected product identifiers, package quantities, and requested delivery time windows. The server sends this order request data to the external delivery service via a network interface and receives order confirmation information such as an order identifier, acceptance status, and expected delivery time.

The terminal receives from the server meal plan information, shortage ingredient information, and order confirmation information. The terminal presents this information in a structured user interface. The terminal, for example, displays a calendar-like view listing meals for each day and meal time, shows dish names and key ingredients, and highlights dishes that are fully covered by current inventory versus dishes that depend on pending deliveries. The terminal also displays order status information, such as expected delivery time and item details, allowing the user to track progress.

The user may perform selection operations or rejection operations on the proposed meal plan.

The user can accept the plan as a whole, mark individual dishes as accepted or rejected, or edit preferences such as “do not show seafood dishes” or “increase use of vegetarian dishes.”

The terminal sends this feedback information to the server in a structured format that indicates, for each dish or ingredient, whether it is accepted or rejected and optionally the reason for rejection.

The server updates preference condition information and restriction condition information based on the received feedback. The server records which dish categories, ingredient categories, or cooking styles have been rejected repeatedly and reduces their selection weight in future evaluation conditions. Conversely, the server may increase weights for accepted or frequently chosen categories. The server then regenerates a prompt sentence that incorporates updated preferences and restrictions, such as additional clauses like “Avoid fish dishes because the user previously rejected fish” or “Prefer warm dishes over cold dishes.” The server re-invokes the generative AI model with this new prompt sentence to obtain a revised meal plan, thereby adaptively improving personalization without requiring manual redefinition of rules.

The terminal may also supply emotional state information derived from sensor-based emotion analysis. The terminal, for instance, captures a short video of the user's face and sends it to an emotion analysis engine. The engine outputs labels such as “stressed,” “sad,” “happy,” or “excited” with confidence scores. The terminal forwards the label to the server. The server then modifies constraint conditions and evaluation conditions by activating predefined sets of food categories associated with particular emotions, such as stress-relief food materials, comforting food materials, or celebratory food materials. The server appends corresponding text to the prompt sentence, for example, “Provide comforting, stress-relief style meals suitable for a stressed user,” thereby systematically incorporating emotional state into the generative planning process.

The described configuration produces technical effects that go beyond mere automation of paper-based meal planning. The server's use of canonical ingredient identifiers, normalized units, indexed nutrition data, and constraint verification routines reduces computational complexity and prevents errors that would arise from ad-hoc textual processing. The generation of structured prompt sentences that encode numerical constraints, emotional context, and user-specific rules allows the generative AI model to operate within a constrained search space, which reduces the number of iterations required to obtain an acceptable meal plan and, therefore, reduces both processing time and network traffic.

The server's closed-loop design, in which the server parses generative AI output, verifies that output against formal constraints, reconciles it with inventory, and automatically triggers external ordering, enables an integrated computational pipeline that conventional systems lack. This pipeline improves data consistency between meal planning, nutritional evaluation, inventory state, and ordering, thereby reducing duplication of calculations and synchronization errors. By capturing user feedback and emotional state and feeding them back into the prompt sentence in a structured manner, the server adapts preference condition information and restriction condition information over time using algorithmic rules that would be difficult to apply manually.

The use of a transformer-based generative AI model, trained with constraint-rich prompt sentences and domain-specific meal plan examples, provides additional technical advantages.

The model internalizes relationships among ingredients, nutritional profiles, and typical dish structures. By supplying detailed constraints in the prompt sentence, the server steers the model to generate plans that already align with energy and nutrient budgets, thereby reducing the amount of post-processing filtering. This yields improved calculation efficiency and reduced latency for the user.

The system, in various alternative embodiments, may implement different internal structures while preserving the same functional principles. In one variation, the server uses an internal, fine-tuned generative AI model hosted on the same hardware rather than an external service, reducing round-trip latency and increasing control over privacy. In another variation, the server employs a hybrid architecture in which a constraint solver or rule-based planner first generates a coarse skeleton of meal categories, and the generative AI model then fills in concrete dishes and descriptions. In yet another variation, the server uses alternative emotion analysis models, such as convolutional neural networks for face images or recurrent neural networks for audio signals, while still mapping emotional states to structured food category weights and encoding them in prompt sentences.

The terminal, in other embodiments, may be a stationary computing apparatus in a kitchen environment, integrated with additional sensors such as weight scales or barcode readers that automatically update ingredient inventory information in the server. The terminal may scan product identifiers and transmit them to the server, which then updates quantities and expiration dates in the database. By integrating such real-world sensing and inventory updates into the same pipeline, the system further reduces manual data entry and enhances the fidelity of inventory information used in planning and ordering.

Through these configurations, the server, the terminal, and the described data structures and algorithms provide an improved computer-implemented system in which generative AI output is tightly integrated with constraint modeling, inventory management, and external device and service control, resulting in improved accuracy, reduced computation and communication overhead, and enhanced adaptability relative to traditional systems that treat these components as isolated modules.

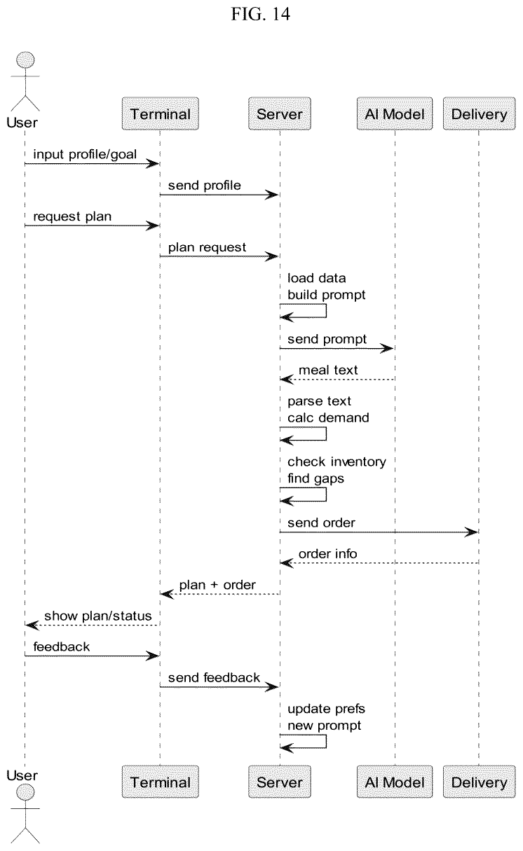

The following describes the processing flow using FIG. 14.

### Step 1:

User operates the terminal to input basic profile and constraints.

User inputs household composition, nutritional condition information (for example, desired protein and vitamin intake), energy condition information (for example, daily calorie limit), preference condition information (likes/dislikes), restriction condition information (allergies, dietary rules), and optionally emotional state (for example, “stressed,” “happy”) via UI elements such as text fields, check boxes, and sliders.

Terminal receives these raw input values as UI events (input: keystrokes, touches; output: in-memory field values), validates formats locally (for example, numeric check for calories), structures them into a record with predefined keys, and constructs a request message (for example, JSON object) including a user identifier.

Terminal sends this structured request to the server over a network connection using HTTPS (input to server: structured user profile and constraint data; output from terminal: HTTP request).

### Step 2:

Server receives and stores user profile and constraints.

Server accepts the HTTPS request from the terminal, parses the request body (input: structured user profile and constraint data; output: parsed data object in server memory), and performs server-side validation (for example, checks value ranges, mandatory fields).

Server executes insert or update operations on a relational database, writing household composition, nutritional condition information, energy condition information, preference condition information, restriction condition information, and emotional state information into appropriate tables (input: parsed data object; processing: mapping fields to database columns, executing SQL statements; output: persistent records in storage).

Server returns an acknowledgement response to the terminal indicating success or, if validation fails, returns error details (input: validation result; output: HTTP response).

### Step 3:

Terminal acquires and sends emotion analysis results (optional).

User allows the terminal to capture image, audio, or text describing current feelings.

Terminal acquires sensor data from device hardware (input: camera frames, microphone samples, or user-typed text; output: raw media or text buffers), and forwards this to an emotion analysis service via an API call.

Terminal receives from the emotion analysis service an estimated emotional state label and confidence (input: media/text; processing at service: feature extraction, classification; output to terminal: emotion label such as “stressed” with score).

Terminal packages the emotional state information with a timestamp and user identifier and sends it to the server as another HTTPS request (input to server: emotion label and metadata; output from terminal: HTTP request).

### Step 4:

Server updates emotional state history.

Server receives the emotional state request, parses it (input: HTTP request; output: in-memory emotion record), and writes a new record to an emotion history table (input: emotion record; processing: SQL insert with user ID and timestamp; output: persistent emotion state entry).

Server optionally marks this emotion as current for the user by updating a reference in the user profile table (input: emotion label; processing: single-row update; output: updated profile record).

Server may confirm receipt to the terminal (input: database update result; output: HTTP response).

### Step 5:

Terminal issues a meal plan generation request.

User initiates generation of a meal plan by selecting a command such as “Generate plan” on the terminal.

Terminal constructs a request message containing a user identifier and optional planning parameters (for example, number of days to plan) (input: user action; processing: mapping button click to request data; output: HTTP request with planning parameters).

Terminal sends this request to the server over HTTPS (input to server: planning command and parameters; output from terminal: HTTP request).

### Step 6:

Server loads user profile, constraints, emotion, and inventory.

Server receives the generation request and reads, from the database, the current user profile, constraint conditions, emotional state, and inventory information (input: user ID and planning parameters; processing: SQL queries to profile, constraints, emotion, and inventory tables; output: combined user state object in memory).

Server also loads nutritional tables and indexing structures into memory if not already cached (input: nutrition table records; processing: building hash maps keyed by ingredient ID; output: in-memory nutrient lookup structures).

Server composes an internal representation of planning requirements (input: combined user state and nutrition data; output: planning context object including nutrient targets, calorie limits, preferences, restrictions, emotion).

### Step 7:

Server computes constraint conditions and evaluation conditions.

Server calculates numeric constraint conditions for energy and nutrients (input: planning context; processing: arithmetic on calorie targets, nutrient ranges, and household composition; output: structured constraint list with bounds and units).

Server computes evaluation conditions based on preference condition information, restriction condition information, and emotional state (input: user preferences, rejections history, emotion label; processing: weighting function that assigns scores to ingredient categories, dish types, and emotional categories; output: evaluation parameter set with weights and penalties).

Server stores these conditions in a data structure that will be used when constructing the prompt sentence (input: constraint and evaluation conditions; output: parameterized condition object).

### Step 8:

Server constructs a prompt sentence for the generative AI model.

Server transforms the condition object into natural-language text by filling a template (input: constraint and evaluation conditions, planning parameters; processing: string concatenation, insertion of numeric values, ingredient names, and emotion labels; output: prompt sentence string).

Server includes in the prompt sentence explicit rules such as calorie limits, required nutrients, prohibited ingredients, liked ingredients, disliked flavors, and emotional context.

Server may log the generated prompt sentence for traceability (input: prompt sentence; processing: write to log; output: log entry).

### Step 9:

Server submits the prompt sentence to the generative AI model and receives response information.

Server sends an API call to the generative AI model endpoint with the prompt sentence and model parameters such as temperature and maximum token count (input: prompt sentence and model settings; processing: HTTP/HTTPS request; output: request payload).

Generative AI model processes the tokenized prompt internally (attention layers, feed-forward layers) and returns generated text (input at model: token sequence; processing: transformer-based inference; output to server: text content with meal plan).

Server receives the response information (input: model response; processing: parse JSON, extract text field; output: meal plan text in memory).

### Step 10:

Server parses response text into structured dish and ingredient information.

Server performs character-string analysis on the meal plan text (input: response text; processing: splitting by lines, headings, bullet markers, and keywords such as “Ingredients:”; output: preliminary segments for days, meals, dishes, and ingredients).

Server extracts dish information including dish names and associated meal times, and extracts ingredient lines from each “Ingredients” list (input: preliminary segments; processing: rule-based parsing, regex matching; output: dish records each with a list of ingredient descriptions).

Server creates an in-memory structure that lists for each day and meal a dish identifier and its ingredient descriptions (input: dish records; output: structured dish and ingredient list).

### Step 11:

Server normalizes ingredient names and units and aggregates quantities.

Server performs name-normalization processing by mapping each ingredient description to a canonical identifier using a controlled vocabulary (input: ingredient descriptions; processing: case normalization, tokenization, similarity matching against known ingredient names; output: canonical ingredient IDs for each ingredient).

Server parses quantity expressions (input: raw quantity text such as “1 cup,” “150 g”; processing: look up conversion rules, extract numeric value and unit; output: standardized numeric quantity and base unit).

Server aggregates quantities per ingredient across all dishes and days (input: canonical IDs with standardized quantities; processing: summation by ingredient ID; output: ingredient demand information mapping each ingredient to a total required amount).

### Step 12:

Server verifies nutritional and energy constraints on the generated plan.

Server computes total calories and nutrients per day by multiplying ingredient demand quantities by nutrient values from the nutrition database (input: ingredient demand information and nutrient component information; processing: table lookup and dot-product-style multiplication and summation; output: per-day nutrition summaries).

Server compares summaries with target ranges in the constraint conditions (input: nutrition summaries and constraints; processing: numeric comparison; output: pass/fail status and list of violated constraints, if any).

Server, if violations occur, optionally modifies or regenerates the prompt sentence (input: violation details; processing: augment prompt with corrective instructions; output: revised prompt sentence), then repeats Steps 9 to 12 until constraints are satisfied or a retry limit is reached.

### Step 13:

Server compares ingredient demand with inventory and identifies shortages.

Server loads current ingredient inventory information from the database (input: user ID; processing: SQL select; output: list of inventory records with ingredient ID, available quantity, unit, expiration).

Server converts available quantities to the same standardized units used in the demand information (input: inventory units and conversion rules; processing: unit conversion; output: standardized available quantities).

Server subtracts available quantities from required quantities for each ingredient (input: ingredient demand and standardized inventory; processing: per-ingredient subtraction; output: shortage ingredient information listing only ingredients with positive deficits and required additional quantities).

### Step 14:

Server generates order candidate information and order request data.

Server sends shortage ingredient information to an external item-information providing service (input: canonical ingredient IDs and required additional quantities; processing: HTTP/HTTPS request; output: query for product candidates).

Server receives item candidate information including product identifiers, package sizes, and prices (input: candidate list; output: product options for each ingredient).

Server selects item combinations to satisfy required quantities using selection rules (input: candidate items and required quantities; processing: cost comparison, package count calculation, threshold checks; output: order candidate information indicating selected products and package counts).

Server composes order request data for the external delivery service, including user address, selected product identifiers, package quantities, and requested delivery window (input: order candidate information and user profile; processing: formatting into service-specific order structure; output: order request payload).

### Step 15:

Server sends orders to external delivery service and records confirmations.

Server transmits the order request data to the external delivery service and awaits a response (input: order request payload; processing: network transmission; output: response payload).

Server receives order confirmation information, parses it (input: confirmation response; processing: JSON/XML parsing; output: order ID, acceptance status, expected delivery time, item list), and writes it to an order history table in the database (input: parsed confirmation; processing: SQL insert; output: persistent order record).

Server updates inventory to reflect pending incoming items if desired (input: order items and quantities; processing: adjust “pending” field; output: updated inventory state).

### Step 16:

Server sends meal plan, shortages, and order information to the terminal.

Server compiles a response that includes structured meal plan information (by day and meal), shortage ingredient information, and order confirmation information (input: structured dish list, shortages, order record; processing: assembly into response object; output: response payload).

Server sends this response to the terminal over HTTPS (input to terminal: response payload; output from server: HTTP response).

### Step 17:

Terminal displays plan and order status to the user.

Terminal receives the response, parses the payload (input: payload; processing: JSON parsing; output: in-memory representation of meals, shortages, orders), and updates UI components.

Terminal renders meal plan information in a calendar or list view and indicates for each dish whether required ingredients are fully available or partially dependent on pending deliveries (input: meal and inventory coverage data; output: visual indicators).

Terminal displays order details, including order ID, expected delivery time, and items, and provides controls for viewing or confirming the order (input: order confirmation information; output: UI elements).

### Step 18:

User provides selection and rejection feedback via the terminal.

User reviews the proposed meal plan and interacts with UI controls to accept, modify, or reject specific dishes or the entire plan.

Terminal records each selection or rejection operation as a structured feedback record (input: user actions; processing: mapping clicked UI elements to dish IDs and verdicts; output: list of feedback entries).

Terminal sends the feedback to the server over HTTPS (input to server: feedback records; output from terminal: HTTP request).

### Step 19:

Server updates preference and restriction conditions and regenerates prompt sentence.

Server receives the feedback, parses it, and updates preference condition information and restriction condition information (input: feedback records; processing: adjust category weights, add or update dislike lists, log rejections; output: modified preference and restriction records in the database).

Server recalculates evaluation conditions based on new preferences and rejections (input: updated preferences; processing: weight recalibration; output: updated evaluation parameter set).

Server generates a new prompt sentence that reflects updated conditions, including explicit instructions derived from past feedback such as “Avoid fish dishes because the user previously rejected fish” (input: updated evaluation parameters and prior constraints; processing: template filling; output: revised prompt sentence).

Server optionally repeats the generative cycle by sending the revised prompt sentence to the generative AI model (input: revised prompt; output: new response text) and then re-executing parsing, constraint verification, and response delivery steps, resulting in a new plan more closely aligned with user behavior.

### Step 20:

Terminal and user iteratively refine usage and monitor deliveries.

Terminal periodically queries the server or receives push notifications about delivery status updates (input: order ID; processing at server: check delivery status, at terminal: update display; output: current delivery status information).

User uses the terminal to adjust future planning parameters, such as changing the number of days to plan or updating household composition.

Server processes these adjustments as in earlier steps, gradually building a personalized, constraint-aware, and inventory-integrated planning cycle that utilizes the generative AI model and prompt sentences to produce technically optimized meal plans.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

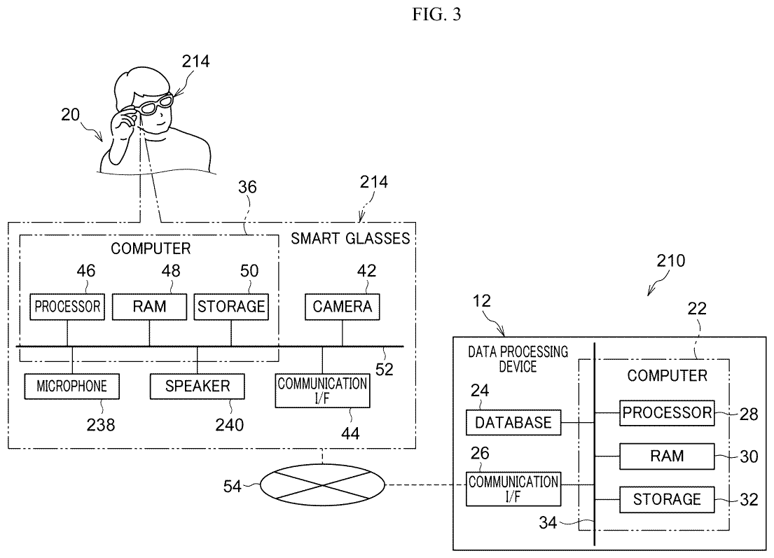

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

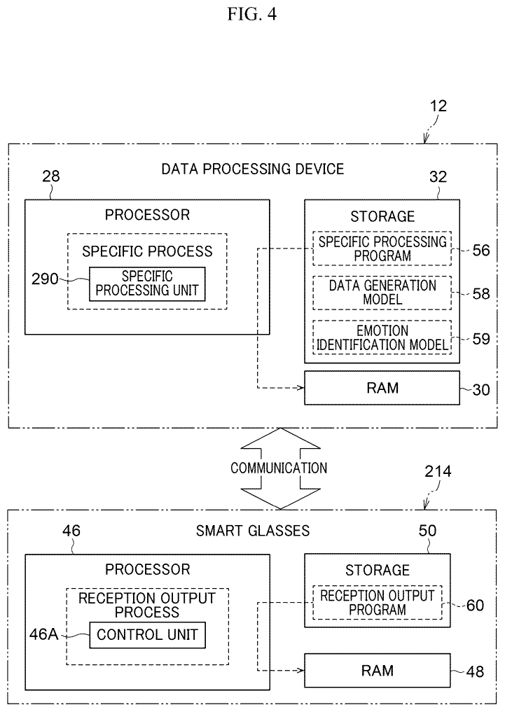

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

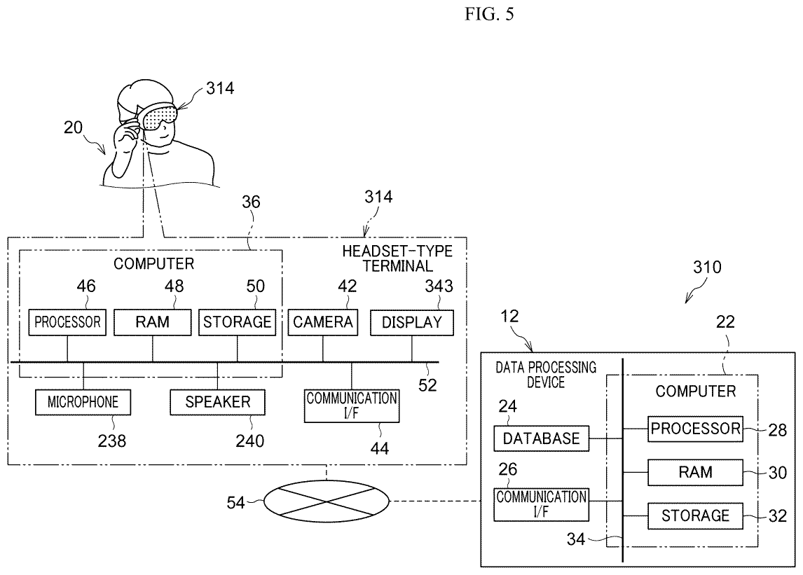

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

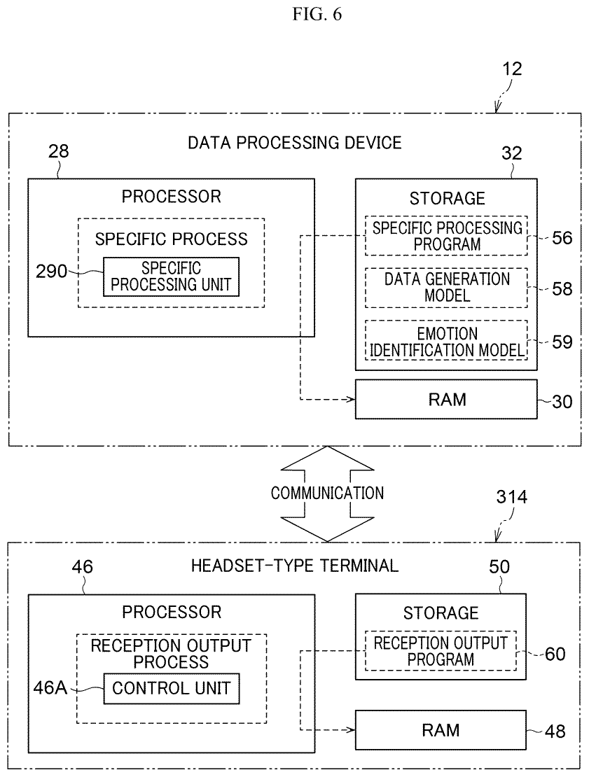

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

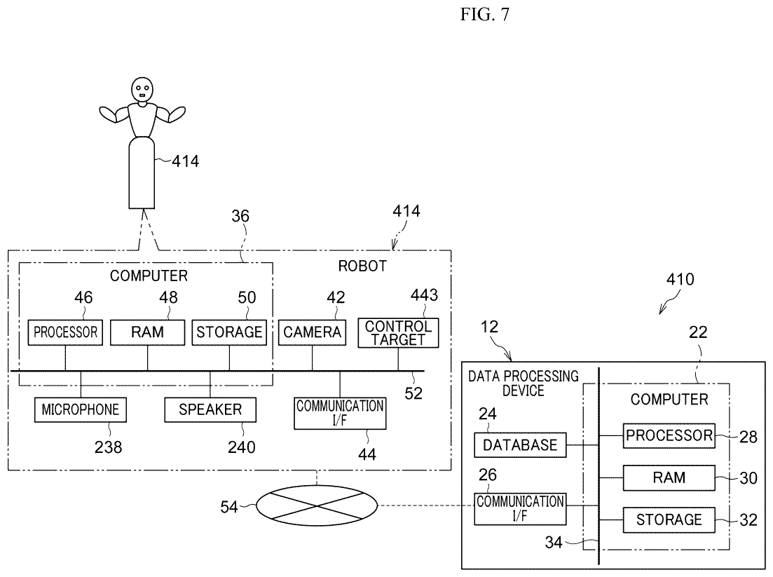

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

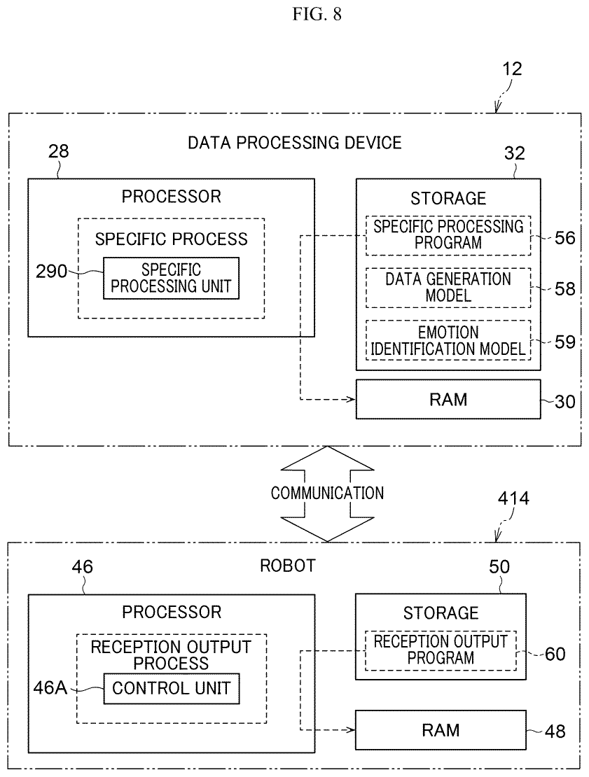

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

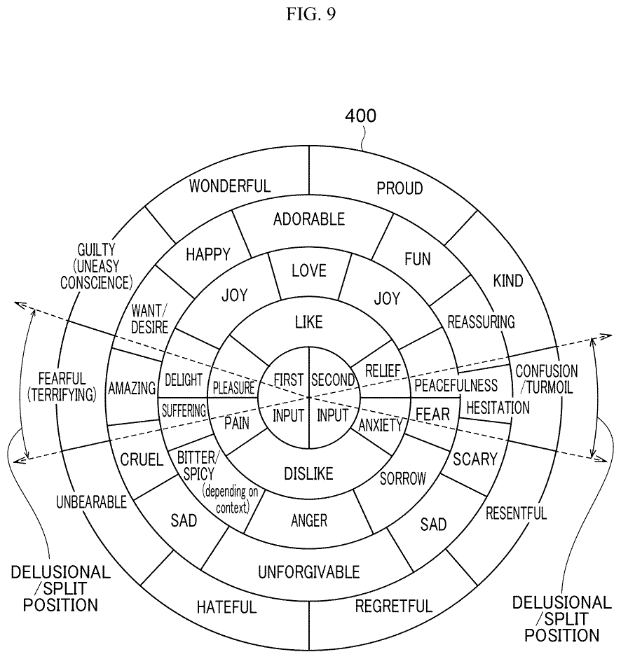

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

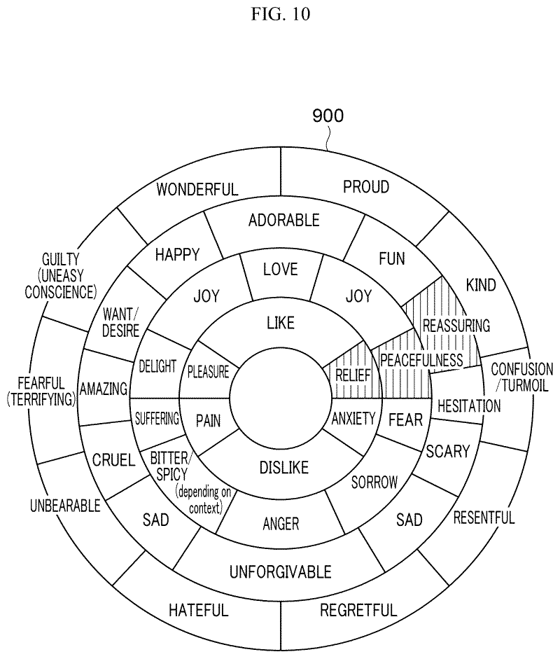

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a terminal, user attribute information and nutritional condition information, generate a prompt sentence including the user attribute information and the nutritional condition information, and input the prompt sentence to a generative information processing model so as to cause the generative information processing model to output meal plan information,
acquire, from a nutrition information storage device, component information corresponding to dish information included in the meal plan information, and calculate nutritional value information and energy amount information for each dish and for a predetermined period,
compare the calculated nutritional value information and energy amount information with the nutritional condition information, and generate corrected meal plan information by changing dish candidate information or serving amount information in accordance with deviation from a target value,
calculate required component amount information based on component information included in the corrected meal plan information, compare the required component amount information with user inventory information, identify shortage component information, and generate shopping list information, and
transmit the corrected meal plan information and the shopping list information to the terminal, provide the corrected meal plan information and the shopping list information in a format displayable by a user interface, and convert the shortage component information into order information in a format transmittable to an external provision service.

### (Supplementary 2)

The system according to supplementary 1,
wherein the processor is configured to
calculate, from the meal plan information or the corrected meal plan information, a total required amount for each component over the predetermined period, generate inventory update information based on a comparison result between the total required amount and the user inventory information, and execute an inventory management process to update the user inventory information.

### (Supplementary 3)

The system according to supplementary 1,
wherein the processor is configured to
acquire emotional state information as a part of the user attribute information, generate the prompt sentence including the emotional state information, input the prompt sentence to the generative information processing model to generate meal plan information including dish information corresponding to an emotional state, and preferentially select component information associated with the emotional state.

### Application Example 1

### (Supplementary 1)

A system comprising a processor,
wherein the processor is configured to
acquire user attribute information and lifestyle information,
perform numerical computation processing on the basis of the user attribute information and the lifestyle information by using a trained inference model included in an information processing apparatus that executes predetermined nutrition calculation processing, and
generate meal plan information including a plurality of meal configuration information in which nutrient allocation and energy intake are defined,
create a prompt sentence in a natural language for causing a generative AI model to generate meal content on the basis of the meal plan information and the user attribute information,
input the prompt sentence to the generative AI model, obtain menu information in the natural language from the generative AI model, and store the meal plan information and the menu information in association with each other,
associate each piece of the meal configuration information included in the meal plan information with preparation information and ingredient information stored in a predetermined preparation information storage area, and calculate types and amounts of ingredients required for an entirety of the meal plan information on the basis of the association,
compare the calculated types and amounts of the ingredients with inventory information stored in an inventory information storage area that stores inventory information of ingredients held by a user, and identify types and amounts of ingredients that are in shortage,
generate order information for an external goods providing service on the basis of the identified types and amounts of the ingredients in shortage, and automatically execute order processing for the ingredients by transmitting the order information via a communication network, and
convert the meal plan information, the menu information, the types and amounts of the ingredients in shortage, and the order information into screen information in a format displayable on a display apparatus, output the screen information, and perform user interaction processing that enables the user to input operation information for confirming or changing the order processing via the screen information.

### (Supplementary 2)

The system according to supplementary 1,
wherein the processor is configured to
include, as the user attribute information and the lifestyle information, at least part of family composition information, target nutrient information, target energy intake information, preference information, allergy information, activity level information, body information, and emotional state information, optimize the meal plan information in the nutrition calculation processing so as to satisfy the target nutrient information and the target energy intake information, and cause the generative AI model to generate the menu information by adding the optimized nutritional conditions and constraint conditions to the prompt sentence input to the generative AI model.

### (Supplementary 3)

The system according to supplementary 1,
wherein the processor is configured to
change selection priority of the preparation information and the ingredient information that are previously associated with stress reduction or induction of positive emotions, on the basis of the emotional state information of the user, in the nutrition calculation processing and generation of the menu information by the generative AI model, and dynamically update the meal plan information and the menu information in accordance with the selection priority.

### Example 2

### (Supplementary 1)

A system comprising a processor and a storage device,
wherein the processor is configured to
receive, as input data via a user interface of a terminal device, user attribute data, nutritional condition data, energy amount condition data, preference condition data, prohibition condition data, and goal condition data, and generate a prompt sentence based on the input data, the prompt sentence instructing a generative AI model to generate meal plan data, and
transmit the prompt sentence to the generative AI model,
obtain, from the generative AI model, response data including period-based meal plan data and ingredient data corresponding to the meal plan data, and analyze the response data to generate structured data including meal data for each day or each meal unit and ingredient list data,
aggregate ingredient data included in the ingredient list data to calculate required ingredient data, compare the required ingredient data with inventory data stored in the storage device to perform comparison operations, identify shortage ingredient data, and generate purchase candidate data or order data based on the shortage ingredient data,
convert the meal plan data, the required ingredient data, and the shortage ingredient data into user-interface data, provide the user-interface data to the terminal device to display the meal plan data and the shortage ingredient data, and accept, via the terminal device, browsing, modification, and confirmation operations by a user,
regenerate the prompt sentence based on modification operations or evaluation data received from the user via the terminal device, instruct the generative AI model to perform partial or entire regeneration of the meal plan data, and reflect regenerated meal plan data in the stored meal plan data, and
update the inventory data based on purchase result data transmitted from the terminal device, and use the updated inventory data in subsequent generation of the prompt sentence and in subsequent identification processing of the shortage ingredient data.

### (Supplementary 2)

The system according to supplementary 1,
wherein the processor is configured to
calculate, based on the user attribute data, the nutritional condition data, the energy amount condition data, and the goal condition data, a total energy amount and a nutrient intake amount for each day or each meal unit in a predetermined period, and embed calculation results in the prompt sentence to be transmitted to the generative AI model, thereby causing the generative AI model to generate meal plan data that satisfies the goal condition data.

### (Supplementary 3)

The system according to supplementary 1,
wherein the processor is configured to
include emotional state data acquired from the user in the prompt sentence, and cause the generative AI model to propose meal data and ingredient data aimed at improvement of mood, reduction of burden, or increase of preference satisfaction, based on a psychological state corresponding to the emotional state data.

### Application Example 2

### (Supplementary 1)

A system comprising a processor,
wherein the processor is configured to
acquire, from a terminal, household composition information, nutritional condition information, energy condition information, preference condition information, restriction condition information, and emotional state information, and store the acquired information in a storage resource,
determine, by computation based on the acquired information and nutrient component information obtained from a nutrition database, constraint conditions and evaluation conditions for a meal plan that satisfies desired nutritional conditions and energy conditions,
generate a prompt sentence including the constraint conditions, the evaluation conditions, the preference condition information, the restriction condition information, and the emotional state information, input the prompt sentence to a generative AI model, and acquire response information including meal plan information from the generative AI model,
extract, from the response information, dish information and ingredient information by character string analysis processing, and perform name normalization processing and quantity aggregation processing on the ingredient information to generate ingredient demand information,
compare, by database matching processing, the ingredient demand information with ingredient inventory information held by a user, and identify shortage ingredient information,
acquire, based on the shortage ingredient information, item candidate information from an external item information providing service, generate order candidate information by associating candidate items with the shortage ingredient information, automatically generate order request data for an external delivery service based on the order candidate information,
transmit the order request data to the external delivery service, and acquire order confirmation information,
transmit the generated meal plan information, the shortage ingredient information, and the order confirmation information to the terminal, and provide, via a user interface, the meal plan information in a display format classified by date and meal category and provide orderable information including delivery status information based on the order confirmation information, and
acquire a selection operation or a rejection operation with respect to the response information from the user, update the preference condition information and the restriction condition information based on contents of the selection operation or the rejection operation, and
regenerate a prompt sentence reflecting the updated condition information and input the regenerated prompt sentence to the generative AI model so as to re-propose meal plan information.

### (Supplementary 2)

The system according to supplementary 1,
wherein the processor is configured to
generate the prompt sentence by determining, based on the household composition information, the nutritional condition information, and the energy condition information, meal planning period information for a predetermined period including a plurality of days, and including the meal planning period information in the prompt sentence so as to acquire, from the generative AI model, meal plan information for the plurality of days corresponding to the predetermined period in a batch manner.

### (Supplementary 3)

The system according to supplementary 1,
wherein the processor is configured to
estimate the emotional state information of the user by emotion analysis processing using at least one of image information, audio information, and text information, and, in generating the prompt sentence, add, to the prompt sentence, conditions relating to at least one of stress-relief food materials, comforting food materials, and celebratory food materials according to the estimated emotional state, thereby acquiring, from the generative AI model, meal plan information corresponding to the emotional state.

What is claimed is:

1. A system comprising:
circuitry configured to:
receive, via a communication interface coupled to a packet-switched network, user attribute information and numerical condition information from a terminal device, and store the received information in a storage device;
generate a prompt sentence comprising the user attribute information and the numerical condition information, and input the prompt sentence to a generative AI model to obtain resource plan information;
acquire component information corresponding to item information included in the resource plan information from a nutrition information storage device, and calculate nutritional value information and energy amount information for each item and for a predetermined period;
compare the calculated nutritional value information and energy amount information with the numerical condition information, and generate corrected resource plan information by adjusting item candidate information or serving amount information based on deviation from a target value;
calculate required component amount information based on component information included in the corrected resource plan information, compare the required component amount information with available inventory information received from the terminal device, and generate a procurement list comprising items for which the required component amount exceeds the available inventory; and
transmit the corrected resource plan information and the procurement list to the terminal device via the communication interface, and initiate a procurement request for at least a portion of the procurement list via the communication interface.

2. The system according to claim 1, wherein the circuitry is configured to receive emotional state data from the terminal device, apply an emotion recognition model to the emotional state data to generate an emotional state representation, and incorporate the emotional state representation as a constraint parameter in the prompt sentence to cause the generative AI model to generate resource plan information adapted to the recognized emotional state.

3. The system according to claim 2, wherein the circuitry is configured to generate resource plan information corresponding to a stress-reduction objective when the emotional state representation indicates a high-stress state, and generate resource plan information corresponding to a social-sharing objective when the emotional state representation indicates a positive state.

4. The system according to claim 3, wherein the circuitry is configured to update the prompt sentence with the emotional state representation at predetermined intervals during a planning session, and regenerate the resource plan information based on the updated prompt sentence.

5. The system according to claim 4, wherein the circuitry is configured to store the emotional state representation and corresponding resource plan information in the storage device, and apply a preference learning model to the accumulated data to update constraint parameters for subsequent prompt sentence generation.

6. The system according to claim 1, wherein the circuitry is configured to apply a target deviation analysis model to the comparison result of the calculated nutritional value information against the numerical condition information, identify items that contribute most to the deviation, and prioritize adjustment of serving amount information for those items in the corrected resource plan information.

7. The system according to claim 6, wherein the circuitry is configured to apply an optimization algorithm to the corrected resource plan information to identify a configuration of item candidates and serving amounts that minimizes aggregate deviation from the target value across all nutritional parameters.

8. The system according to claim 1, wherein the circuitry is configured to receive user attribute information comprising at least a group composition parameter, an activity level parameter, and an allergy constraint parameter, and apply the allergy constraint parameter as a hard exclusion filter on item candidates included in the resource plan information.

9. The system according to claim 8, wherein the circuitry is configured to apply a dietary preference scoring model to the remaining item candidates after allergy filtering, and rank item candidates by preference score for inclusion in the corrected resource plan information.

10. The system according to claim 1, wherein the circuitry is configured to track inventory information updates received from the terminal device over a planning period, and recalculate the required component amount information relative to the updated inventory information to generate a revised procurement list.

11. The system according to claim 10, wherein the circuitry is configured to apply a freshness model to the inventory information to identify items that have exceeded a predetermined freshness threshold, and prioritize those items as preferred components in the resource plan information.

12. The system according to claim 1, wherein the circuitry is configured to apply a plan goal classifier to a goal parameter included in the user attribute information to classify the planning goal into predefined categories, and generate the prompt sentence to include goal-specific constraint parameters corresponding to the classified planning goal.

13. The system according to claim 12, wherein the circuitry is configured to generate multiple resource plan information variants corresponding to different planning goals, and transmit all variants to the terminal device for user selection.

14. The system according to claim 1, wherein the circuitry is configured to apply a natural language processing model to user preference text received from the terminal device to extract structured preference parameters, and incorporate the extracted preference parameters in the prompt sentence for resource plan generation.

15. The system according to claim 14, wherein the circuitry is configured to apply a semantic similarity model to the extracted preference parameters to identify related item candidates from the nutrition information storage device, and include the related item candidates as suggestions in the prompt sentence.

16. The system according to claim 1, wherein the circuitry is configured to receive feedback data from the terminal device indicating user acceptance or modification of the resource plan information, and apply a feedback integration model to update the prompt sentence generation rules based on the feedback data.

17. The system according to claim 16, wherein the circuitry is configured to apply a reinforcement learning model to accumulated feedback data stored in the storage device to improve alignment between generated resource plan information and user preferences over time.

18. A system comprising:
circuitry configured to:
receive, via a communication interface coupled to a packet-switched network, user attribute information comprising a group composition parameter, an activity level parameter, and an allergy constraint parameter, and numerical condition information from a terminal device;
generate a prompt sentence incorporating the user attribute information and the numerical condition information, input the prompt sentence to a generative AI model to obtain resource plan information, and apply the allergy constraint parameter as a hard exclusion filter on item candidates;
calculate nutritional value information and energy amount information for each item in the resource plan information, compare against the numerical condition information, and generate corrected resource plan information by applying an optimization algorithm to minimize aggregate deviation from target values;
receive emotional state data from the terminal device, apply an emotion recognition model to generate an emotional state representation, and incorporate the emotional state representation as a constraint parameter in an updated prompt sentence;
compare required component amount information with available inventory information to generate a procurement list, initiate a procurement request for items in the procurement list, and transmit the corrected resource plan information and the procurement list to the terminal device.

19. The system according to claim 18, wherein the circuitry is configured to receive feedback data from the terminal device indicating user acceptance or modification of the resource plan information, apply a reinforcement learning model to accumulated feedback data to improve alignment between generated resource plan information and user preferences, and update prompt sentence generation rules based on the accumulated feedback data.

20. A method comprising:
receiving, via a communication interface coupled to a packet-switched network, user attribute information and numerical condition information from a terminal device, and storing the received information in a storage device;
generating a prompt sentence comprising the user attribute information and the numerical condition information, and inputting the prompt sentence to a generative AI model to obtain resource plan information;
acquiring component information corresponding to item information included in the resource plan information from a nutrition information storage device, and calculating nutritional value information and energy amount information for each item and for a predetermined period;
comparing the calculated nutritional value information and energy amount information with the numerical condition information, and generating corrected resource plan information by adjusting item candidate information or serving amount information based on deviation from a target value;
calculating required component amount information based on component information included in the corrected resource plan information, comparing the required component amount information with available inventory information received from the terminal device, and generating a procurement list comprising items for which the required component amount exceeds the available inventory; and
transmitting the corrected resource plan information and the procurement list to the terminal device via the communication interface, and initiating a procurement request for at least a portion of the procurement list via the communication interface.
